(19) United States
(12) Patent Application Publication
(10) Pub. No.: US 2025/0274222 A1
(43) Pub. Date: Aug. 28, 2025

(54) METHODS, ARCHITECTURES, APPARATUSES AND SYSTEMS DIRECTED TO HYBRID AUTOMATIC REPEAT REQUEST (HARQ) OPERATIONS FOR SIDELINK COMMUNICATIONS IN UNLICENSED SPECTRUM

(71) Applicant: InterDigital Patent Holdings, Inc., Wilmington, DE (US)

(72) Inventors: Tao Deng, New York, NY (US); Tuong Hoang, Montreal (CA); Aata El Hamss, Laval (CA); Moon-il Lee, Melville, NY (US); Patrick Tooher, Montreal (CA); Martino Freda, Laval (CA)

(73) Assignee: InterDigital Patent Holdings, Inc., Wilmington, DE (US)

(21) Appl. No.: 18/857,310

(22) PCT Filed: Apr. 26, 2023
(86) PCT No.: PCT/US2023/020013

§ 371 Date: Oct. 16, 2024

Related U.S. Application Data
(60) Provisional application No. 63/335,134, filed on Apr. 26, 2022.
(60) Provisional application No. 63/395,620, filed on Aug. 5, 2022.
(60) Provisional application No. 63/421,632, filed on Nov. 2, 2022.

(51) Int. Cl. H04L 1/1812; H04L 27/26; H04W 72/25; H04W 74/0808

(52) U.S. Cl. CPC H04L 1/1812; H04L 27/2607; H04W 72/25; H04W 74/0808

(57) ABSTRACT

Procedures, methods, architectures, apparatuses, systems, devices, and computer program products directed to hybrid automatic repeat request (HARQ) operations for sidelink communications in unlicensed spectrum are provided. Among the methods is a method that may include performing a channel access procedure for a physical sidelink feedback channel (PSFCH) transmission at one or more of one or more transmission occasions that may occur within a HARQ latency bound.

### CROSS-REFERENCE TO RELATED APPLICATIONS

This application claims the benefit of U.S. Provisional Patent Application Nos. (i) 63/335,134 filed Apr. 26, 2022, (ii) 63/395,620 filed Aug. 5, 2022, and (iii) 63/421,632 filed Nov. 2, 2022; each of which is incorporated herein by reference.

### BACKGROUND

This application is related to wired and/or wireless communications, including, for example, methods, architectures, apparatuses and systems directed to hybrid automatic repeat request (HARQ) operations for sidelink communications in unlicensed spectrum.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures and the detailed description are not to be considered limiting, and other equally effective examples are possible and likely. Furthermore, like reference numerals (“ref.”) in the Figures indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates example physical sidelink feedback channel (PSFCH) slot formats and PSFCH transmission occasion configurations;

FIG. 3 illustrates examples of PSFCH transmissions and associated physical sidelink shared channel (PSSCH) transmissions and/or physical sidelink control channel (PSCCH) transmissions (“PSSCH/PSCCH transmissions”) carried out during a same channel occupancy time (COT);

FIGS. 4A-4B illustrate examples of initial transmission and blind re-transmissions along with associated PSFCH transmissions carried out during one or more COTs;

FIGS. 5A-B illustrate examples of initial transmissions and blind re-transmissions along with associated PSFCH transmissions and associated hybrid automatic repeat request (HARQ) status transmissions carried out during a COT;

FIGS. 6A-B illustrate examples of initial transmission, blind re-transmissions and PSSCH/PSCCH transmissions along with associated PSFCH transmissions carried out during one or more COTs;

FIG. 7 illustrates examples of PSFCH transmissions in a COT based on transmit WTRU polling;

FIG. 8 illustrates examples of PSFCH transmissions in a shared COT;

FIG. 9 illustrates examples of HARQ feedback in a COT initiated for PSFCH transmissions;

FIG. 10 is a flow chart illustrating an example flow for carrying out initial transmission and second transmission along with associated PSFCH transmissions during one or more COTs;

FIG. 11 is a flow chart illustrating an example flow for carrying out non-contiguous initial transmission and HARQ re-transmission within a single COT; and

FIG. 12 is a flow chart illustrating an example flow for carrying out non-contiguous initial transmission and HARQ re-transmission within two or more COTs.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

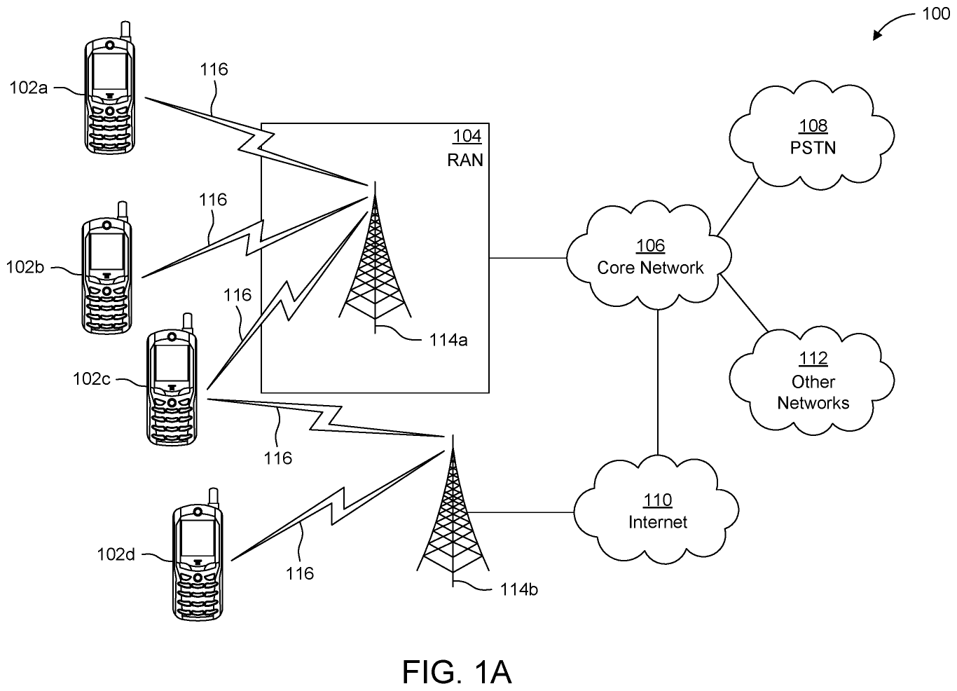

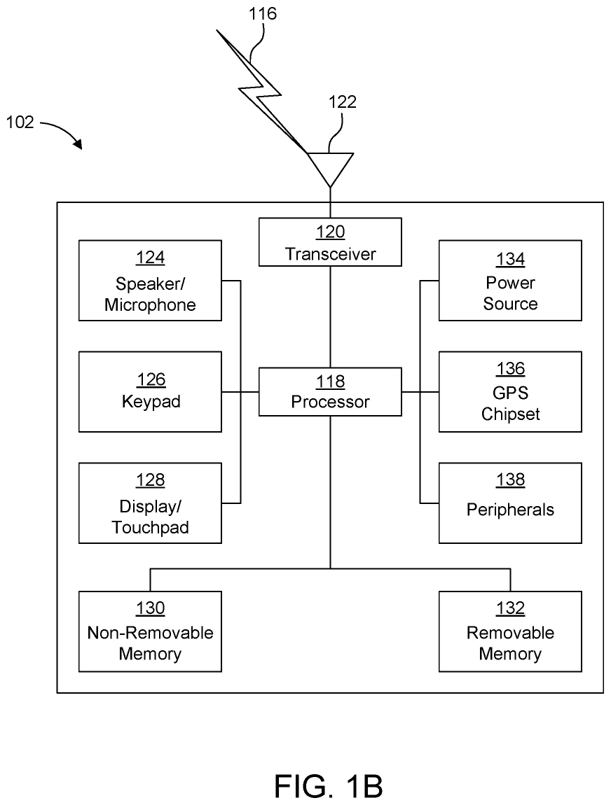

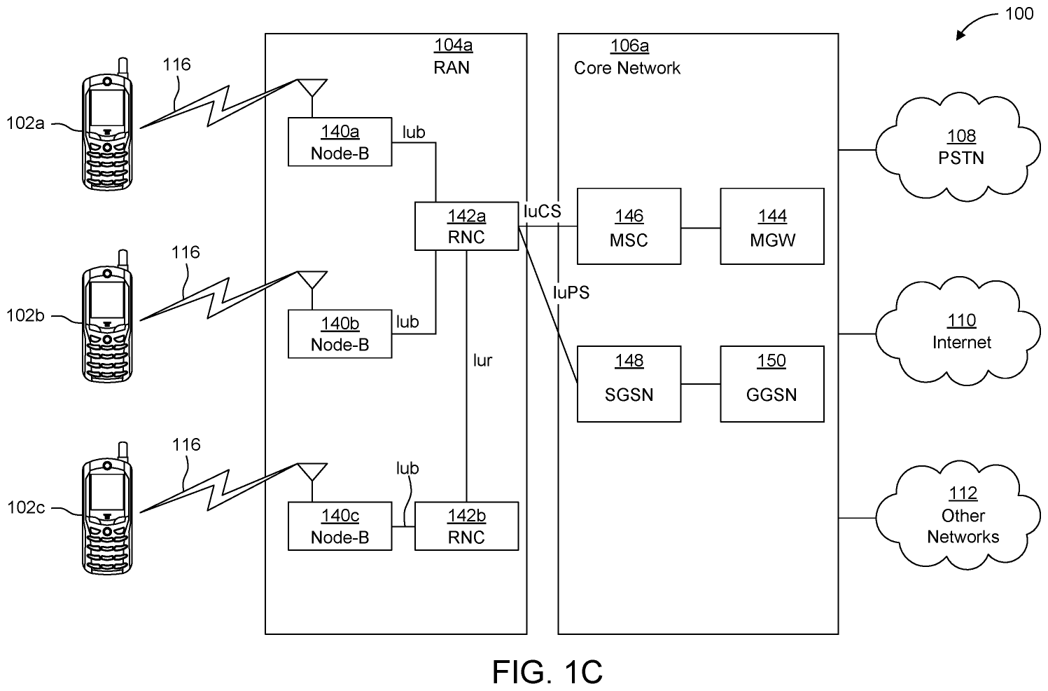

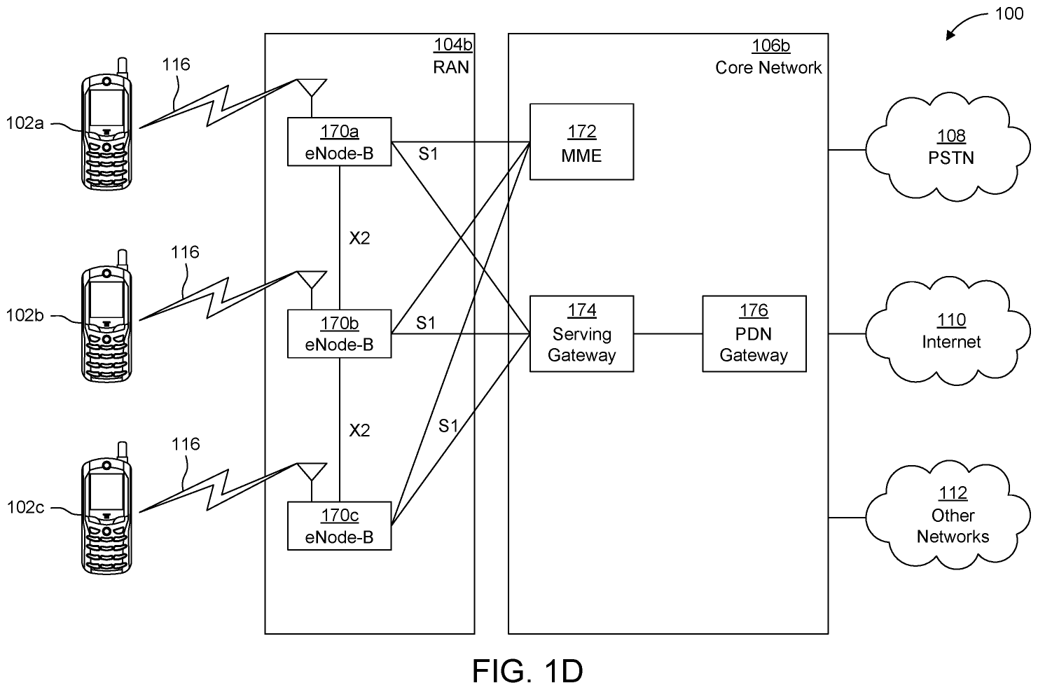

The methods, apparatuses and systems provided herein are well-suited for communications involving both wired and wireless networks. Wired networks are well-known. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram of an example communications system 100 in which one or more disclosed embodiments may be implemented. Example communications system 100 is provided for the purpose of illustration only and is not limiting of the disclosed embodiments. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronic device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. Example WTRU 102 is provided for the purpose of illustration only and is not limiting of the disclosed embodiments. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. For example, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules/units that provide additional features, functionality and/or wired or wireless connectivity. For example, the peripherals 138 may include an accelerometer, an e-compass, a satellite transceiver, a digital camera (e.g., for photographs or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram of the RAN 104 and the CN 106 according to another embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The core network 106 shown in FIG. 1C may include a mobility management gateway (MME) 162, a serving gateway (SGW) 164, and a packet data network (PDN) gateway 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may also perform other functions, such as anchoring user planes during inter-eNode-B handovers, triggering paging and/or mobile termination when DL data is available for the WTRUs 102a, 102b, 102c, managing and storing contexts of the WTRUs 102a, 102b, 102c, and the like.

The SGW 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set mode may have an Access Point (AP) for the basic service set and one or more stations (STAs) associated with the AP. The AP may have an access or an interface to a Distribution System (DS) or another type of wired/wireless network that carries traffic in to and/or out of the basic service set. Traffic to STAs that originates from outside the basic service set may arrive through the AP and may be delivered to the STAs. Traffic originating from STAs to destinations outside the basic service set may be sent to the AP to be delivered to respective destinations. Traffic between STAs within the basic service set may be sent through the AP, for example, where the source STA may send traffic to the AP and the AP may deliver the traffic to the destination STA. The traffic between STAs within a basic service set may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an independent basic service set mode may not have an AP, and the STAs (e.g., all of the STAs) within or using the independent basic service set may communicate directly with each other. The independent basic service set mode of communication may sometimes be referred to herein as an “ad-hoc” mode of communication.

When using the 802.1 lac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the basic service set and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given basic service set.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to a Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11 ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the basic service set. The bandwidth of the primary channel may be set and/or limited by a STA, from among all STAs in operating in a basic service set, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the basic service set support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different packet data unit (PDU) sessions with different requirements), selecting a particular SMF 183a, 183b, management of the registration area, termination of non-access-stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

### Sidelink Operation in Unlicensed Spectrum

It was agreed in RAN #94 that a sidelink evolution work item for 3GPP release 18 (“R18 SL Evolution WI”) is to include a study of support of sidelink operation for both mode 1 and mode 2 in unlicensed spectrum in frequency range 1 (FR1). The unlicensed sidelink frequency bands are 5 GHz and 6 GHz and the Uu operation related to Mode 1 is limited to licensed spectrum only. The channel access design for sidelink in unlicensed spectrum (SL U) is to be based on regional regulation requirements with existing channel access for NR in unlicensed spectrum (NR U) as a starting point.

R16 SL resource allocation mechanism specified for licensed spectrum can be re-used. The scope of R18 SL evolution work item may include determining, evaluating and/or specifying required changes to NR SL physical (PHY) channel structures and procedures to operate in unlicensed spectrum. Hybrid automatic repeat request (HARQ) feedback support in NR V2X for unicast transmissions and/or groupcast transmissions is likely to be evaluated in the R18 SL evolution work item discussions.

### NR U Channel Access

In NR U, a WTRU can access a channel for uplink transmission(s) according to a Type 1 uplink channel access procedure or a Type 2 uplink channel access procedure. The Type 1 and Type 2 uplink channel access procedures are designed to comply with regulatory requirements related to e.g., sensing (e.g., listen before talk (LBT) sensing), maximum channel occupancy time (MCOT), occupied channel bandwidth (OCB) and power spectral density (PSD).

The Type 1 channel access procedure includes performing LBT sensing with random back-off and a variable extended clear channel assessment (CCA) period based on a contention window of which the size is selected based on channel access priority class (CAPC) configuration. A gNB or WTRU must perform the Type 1 channel access procedure to initiate a COT. The Type 2 uplink channel access procedure may be one or a Type 2A uplink channel access procedure, a Type 2B uplink channel access procedure and a Type 2C uplink channel access procedure. The Type 2A and 2B uplink channel access procedures are performed when a gap in transmission (“transmission gap”) is 25 microseconds (∪s) and 16 μs, respectively. When a transmission gap is smaller than 16 μs, the Type 2C uplink channel access procedure is applied with an immediate transmission after the transmission gap without performing sensing.

For downlink transmissions, NR U adds COT structure indication, dynamic PDCCH monitoring and flexible starting positions for physical downlink shared channel (PDSCH) transmissions because of uncertainty caused by LBT sensing. For uplink control and data channel transmissions, to comply with the OCB requirement, new block interlaced based transmissions are used for PUCCH and PUSCH transmissions with flexible starting positions for the PUSCH transmissions. The NR U SRS transmissions are also enhanced with additional flexibility in configuration and triggering. In addition, NR U supports frame structure with multiple downlink to uplink (DL-to-UL) and uplink to downlink (UL-to-DL) switching points within a shared COT.

NR U supports additional HARQ transmission opportunities and immediate HARQ transmission for corresponding data in the same shared COT as well as the subsequent COT to ensure the channel access of HARQ transmissions.

In R17 V2X, a set of frequency and code resources (e.g., physical resource block(s) (PRBs) and sequence resources) are pre-configured in a resource pool dedicated for a physical sidelink feedback channel (PSFCH) transmission carrying sidelink HARQ feedback. A one-to-one association between a PSFCH transmission and an associated physical sidelink shared channel (PSSCH) transmission and/or physical sidelink control channel transmission (“PSSCH/PSCCH transmission”) is implicitly indicated in the resource used for PSFCH transmissions, as it is determined based on resource allocation information for the PSSCH/PSSCH transmission. Such an implicit association relies on a deterministic time and frequency relationship between a PSSCH/PSCCH transmission and corresponding PSFCH transmission and will not work in unlicensed spectrum, because the PSFCH transmission can be transmitted in a different COT after a random time period as a result of LBT uncertainty. Thus, a new mechanism is needed for channel access for PSFCH transmission and related association with the corresponding PSSCH/PSCCH transmission.

Consecutiveness of transmissions within a COT is important because, in shared spectrum, a device is not permitted to transmit after a gap in transmission of a certain duration (e.g., a transmission gap of a given duration) and another channel access procedure has to be performed to (re-)acquire a channel for transmissions. In NR U, a gNB schedules all transmissions within a COT shared by gNB and one or more WTRUs. The coordination by the centralized node ensures the consecutiveness of transmissions within the COT. In the sidelink operation for mode 2 in unlicensed spectrum (“Mode 2 SL U”), coordination of transmissions of different WTRUs within a COT (and/or in different COTs) is not or likely not carried out by a centralized node. It is important in Mode 2 SL U that the coordination of transmissions of different WTRUs achieve a seamless connection so as to avoid a transmission gap (e.g., an unintentional transmission gap) within a COT, e.g., when sharing the COT among PSSCH/PSCCH and PSFCH transmissions of the different WTRUs, where one or more transmit/receive (Tx/Rx) switching points of one or more of the WTRU may occur within a COT.

### Overview

Methods, apparatuses, systems, etc. directed to, and/or in connection with, for carrying out HARQ operations for sidelink communications, e.g., in unlicensed spectrum are disclosed herein. Such methods, apparatuses, systems, etc., for example, may address the involvement of (methodologies and technologies configured in, implemented in and/or carried out by) apparatuses and systems for performing initial transmission and subsequent transmission (e.g., blind re-transmissions) along with associated PSFCH transmissions during one or more COTs.

For simplicity of exposition, the disclosure that follows is in part from a perspective of a WTRU. Those of ordinary skill in the art will recognize that much of such disclosure may be equally applicable to a network element (e.g., a base station or other RAN element), other network element and/or a network function, and hence, such modifications and variations are intended to fall within the scope of the disclosure and the appended claims.

In various embodiments, a first method may include any of:
receiving, during a first COT established for device-to-device communications, an initial transmission of first control information and a transport block followed by a second transmission of second control information and the same transport block, wherein (i) at least the first control information may indicate a first transmission occasion within the first COT, and (ii) at least the second control information may indicate a latency bound for reporting HARQ feedback for the transport block; determining a first HARQ feedback for the transport block, wherein the first HARQ feedback may be and/or may include comprises a non-acknowledgement; performing a first channel access procedure during the first COT; transmitting a third transmission indicating the first HARQ feedback during the first transmission occasion; determining a second HARQ feedback for the transport block; determining, from one or more transmission occasions, a second transmission occasion that satisfies the latency bound; performing a second channel access procedure and establishing a second channel occupancy time for device-to-device communications at the second transmission occasion; and transmitting a fourth transmission indicating the second HARQ feedback at the second transmission occasion.

In various embodiment, any of the initial transmissions and the second transmission is a PSCCH transmission, a PSSCH transmission, or a combination of a PSCCH transmission and a PSSCH transmission. In various embodiment, the first control information may be and/or may include SCI, and wherein the first transmission occasion may be a transmission occasion for a PSFCH transmission. In various embodiments, the transmission occasion may be a slot.

In various embodiments, the second transmission occasion may be based on a PSSCH-to-PSFCH association between different COTs.

In various embodiments, the first method may include determining one or more resources for the fourth transmission in terms of a frequency allocation based on any of a transmission occasion index, a source identifier, a destination identifier and a channel occupancy time index. In various embodiments, the frequency allocation may be and/or may include any of an RB, an RB interlace, a sub-channel, a CS and a CS index.

In various embodiments, determining a first HARQ feedback for the transport block may include determining the first HARQ feedback for the transport block for the initial transmission. In various embodiments, determining a second HARQ feedback for the transport block may include determining the second HARQ feedback for the transport block for the initial transmission and the second transmissions collectively.

In various embodiments, the transmission occasions are configured (e.g., to the WTRU or based on a pool).

In various embodiments, the second channel occupancy time may be initiated by the WTRU or another WTRU. In various embodiments, the WTRU may be a first WTRU, the first COT may be initiated by a second WTRU, and receiving an initial transmission and a second transmission may include receiving the initial transmission and the second transmission from the second WTRU.

In various embodiments, the second transmission may occur after at least one fifth transmission of third control information and the same transport block. In various embodiments, the third control information may indicate, may be and/or may include any of the first transmission occasion and the latency bound.

In various embodiments, determining a second HARQ feedback for the transport block may include determining the second HARQ feedback for the transport block for the initial transmission, the at least one fifth transmission and the second transmissions collectively.

In various embodiments, the first channel access procedure may be a type 1 channel access procedure. In various embodiments, the second channel access procedure may be a type 2 channel access procedure.

In various embodiments, the first method may be implemented in a WTRU.

In various embodiments, a second method may include any of: performing a first transmission of first information during a COT; performing one or more blind re-transmissions of the first information during the COT following the first transmission; and receiving a second transmission during the COT following the one or more blind transmissions. In various embodiments, the second transmission may be and/or may include second information indicating HARQ status information for the first information.

In various embodiments, the second information indicating HARQ status information for the first information may indicate, may be and/or may include third information indicating the HARQ status information may be based on decoding results of one or more of the first transmission and the one or more blind re-transmissions.

In various embodiments, the second information may indicate, may be and/or may include fourth information indicating the HARQ status information may be based on decoding results of any of (i) the first transmission and one or some of the blind re-transmissions, (ii) some of the blind re-transmissions, (iii) the first transmission and all of the blind re-transmissions, and (iv) all of the blind re-transmissions.

In various embodiments, the HARQ status information may indicate an acknowledgement (e.g., a HARQ acknowledgement). Alternatively, in various embodiments, the HARQ status information may indicate a non-acknowledgement (e.g., a HARQ non-acknowledgement).

In various embodiments, the second transmission may be and/or may include a MAC control element (MAC CE). In various embodiments, the MAC CE may indicate and/or may include the second information.

In various embodiments, the second method may include performing a HARQ re-transmission during the COT and following the second transmission.

In various embodiments, the COT may be a first COT, the HARQ status information is first HARQ status information, and the method may include receiving a third transmission during a second COT following the first COT. In various embodiments, the third transmission may be and/or may include fifth information indicating second HARQ status information for the first information.

In various embodiments, the second method may include performing a HARQ re-transmission during the second COT.

In various embodiments, the HARQ re-transmission may be a first HARQ re-transmission, and the second method may include performing a second HARQ re-transmission during the second COT.

In various embodiments, the second method may include performing a third HARQ re-transmission during a third COT.

In various embodiments, the HARQ re-transmission may be a first HARQ re-transmission, and the second method may include performing a HARQ re-transmission during a third COT.

In various embodiments, the HARQ re-transmission may be a first HARQ re-transmission, and the second method may include performing a second HARQ re-transmission during a third COT.

In various embodiments, the third COT may occur after the first COT. In various embodiments, the third COT may occur prior to the second COT.

In various embodiments, the second HARQ status information may indicate, may be and/or may include an acknowledgement (e.g., a HARQ acknowledgement). In various embodiments, the second HARQ status information may indicate, may be and/or may include a non-acknowledgement (e.g., a HARQ non-acknowledgement).

In various embodiments, the fifth information may indicate, may be and/or may include second information indicating the second HARQ information may be based on decoding results of one or more of the first transmission and the blind re-transmissions.

In various embodiments, the fifth information may indicate, may be and/or may include seventh information indicating the second HARQ status information may be based on decoding results of any of (i) the first transmission and one or some of the blind re-transmissions, (ii) some of the blind re-transmissions, (iii) the first transmission and all of the blind re-transmissions, and (iv) all of the blind re-transmissions.

In various embodiments, the MAC CE may be a first MAC CE, and/or the third transmission may be and/or may include a second MAC CE that may indicate and/or include the fifth information.

In various embodiments, the first transmission may be and/or may include any of an initial transmission and a HARQ re-transmission. In various embodiments, the initial transmission may be and/or may include a PSFCH transmission.

In various embodiments, the second method may be implemented in a WTRU.

In various embodiments, a third method may include any of: receiving a first transmission of first information performed during a COT; and performing a second transmission during the COT following one or more third transmissions performed after the first transmission. In various embodiments, the third transmissions may be and/or may include one or more blind re-transmissions of the first information, and the second transmission may be and/or may include second information indicating HARQ status information for the first information. In various embodiments, the third method may include receiving one or more of the blind re-transmissions.

In various embodiments, the second information may indicate, may be and/or may include third information indicating the HARQ status information is based on decoding results of one or more of the first transmission and one or more of the blind re-transmissions.

In various embodiments, the second information may indicate, may be and/or may include fourth information indicating the HARQ status information may be based on decoding results of any of (i) the first transmission and one or some of the blind re-transmissions, (ii) some of the blind re-transmissions, (iii) the first transmission and all of the blind re-transmissions, and (iv) all of the blind re-transmissions.

In various embodiments, the HARQ status information may indicate, may be and/or may include an acknowledgement (e.g., a HARQ acknowledgement). Alternatively, in various embodiments, the HARQ status information may indicate, may be and/or may include a non-acknowledgement (e.g., a HARQ non-acknowledgement).

In various embodiments, the second transmission may be and/or may include a MAC CE that may indicate and/or may include the second information.

In various embodiments, the third method may include determining the HARQ status information (not shown).

In various embodiments, the third method may include receiving a HARQ re-transmission during the COT and following the second transmission (not shown).

In various embodiments, the COT may be a first COT, the HARQ status information may be and/or may include first HARQ status information, and the third method may include performing a fourth transmission during a second COT following the first COT. In various embodiments, the fourth transmission may be and/or may include fifth information indicating second HARQ status information for the first information.

In various embodiments, the HARQ re-transmission may be a first HARQ re-transmission, and the third method may include receiving a second HARQ re-transmission during the second COT. In various embodiments, the third method may include receiving a HARQ re-transmission during the second COT.

In various embodiments, the third method may include receiving a third HARQ re-transmission during a third COT.

In various embodiments, the HARQ re-transmission may be a first HARQ re-transmission, and the third method may include receiving a second HARQ re-transmission during a third COT. In various embodiments, the HARQ re-transmission may be a first HARQ re-transmission, and the third method may include receiving a second HARQ re-transmission during a third COT. In various embodiments, the third COT occurs after the first COT. In various embodiments, the third COT occurs prior to the second COT.

In various embodiments, the HARQ status information may indicate an acknowledgement (e.g., a HARQ acknowledgement). In various embodiments, the second HARQ status information may indicate a non-acknowledgement (e.g., a HARQ non-acknowledgement).

In various embodiments, the fifth information may indicate, may be and/or may include sixth information indicating the second HARQ status information may be based on decoding results of one or more of the first transmission and the blind re-transmissions.

In various embodiments, the fifth information may indicate, may be and/or may include third information indicating, the second HARQ status information may be based on decoding results of any of (i) the first transmission and one or some of the blind re-transmissions, (ii) some of the blind re-transmissions, (iii) the first transmission and all of the blind re-transmissions, and (iv) all of the blind re-transmissions.

In various embodiments, the MAC CE may be a first MAC CE, the fourth transmission may be a second MAC CE, and/or the second MAC CE may include the fifth information.

In various embodiments, the third method may include determining the second HARQ status information. In various embodiments, the first transmission may be and/or including any of an initial transmission and a HARQ re-transmission. In various embodiments, the initial transmission may be and/or may include a PSFCH transmission.

In various embodiments, the third method may be implemented in a WTRU.

In various embodiments, a fourth method may include any of: performing channel access for a first transmission at one or more of one or more transmission occasions that occur within a HARQ latency bound. In various embodiments, the first transmission may be and/or may include first information indicating HARQ status information associated with a second transmission performed during a COT.

In various embodiments, the fourth method may be implemented in a WTRU.

In various embodiments, a fifth method may include: performing channel access for PSFCH transmission at one or more of one or more transmission occasions that occur within a HARQ latency bound.

In various embodiments, the fifth method may be implemented in a WTRU.

In various embodiments, a sixth method may include any of: performing non-contiguous initial transmission and HARQ request re-transmission within a COT based on an associated channel being determined to be available for a time between the initial transmission and a transmission opportunity for performing the HARQ re-transmission.

In various embodiments, the sixth method may be implemented in a WTRU.

In various embodiments, a seventh method may include any of: determining a channel is available within a COT at a time between an initial transmission and a transmission opportunity for performing a HARQ re-transmission; and performing non-contiguous initial transmission and HARQ re-transmission within the channel occupancy time based on determining the channel is available.

In various embodiments, the seventh method may be implemented in a WTRU.

In various embodiments, an eighth method may include any of: determining a channel is not available within a first COT at a time following an initial transmission and a transmission opportunity for performing a HARQ re-transmission; and performing non-contiguous initial transmission and HARQ re-transmission within the first COT and a second COT based on determining the channel is not available.

In various embodiments, the eighth method may be implemented in a WTRU.

In various embodiments, a thirteen method may include: performing HARQ re-transmission of an earlier transmission based on control information received during a COT initiated for a transmission. In various embodiments, the transmission may include information indicating HARQ status information associated with the earlier transmission.

In various embodiments, the eighth method may be implemented in a WTRU.

In various embodiments, a ninth method may include performing HARQ re-transmission based on information of SCI received in a COT initiated for an associated PSFCH transmission.

In various embodiments, the ninth method may be implemented in a WTRU.

In various embodiments, an apparatus comprising circuitry, including a transmitter, a receiver, a processor and memory, configured to perform at least one of the foregoing methods.

In various embodiments, apparatus may be, may be configured as and/or may be configured with elements of, a WTRU.

### Representative SL U PSSCH/PSCCH and PSFCH Transmission

Channel access for PSSCH/PSCCH transmissions and/or PSFCH transmissions may be carried out, used, defined, configured and/or determined. In various embodiments, a WTRU may perform a channel access and resource selection procedure in SL U. The SL U channel access and resource selection procedure may be to initiate a COT and/or to share an on-going COT. A WTRU may perform one more sidelink contiguous transmissions in an initiated COT and/or a shared COT.

The SL U channel access and resource selection procedure may include LBT sensing and SCI sensing. For example, channel access may be based on LBT sensing (“LBT sensing based channel access”) may be based on Type 1 channel access procedure. A WTRU may perform a LBT sensing, may determine based on and/or response to the LBT sensing an availability of a SL U channel, and/or may perform transmission(s) on the SL U channel based on, responsive to and/or conditioned on the SL U channel being available. A SL U channel may refer to a resource pool and/or a resource block (RB) set. The resource pool and/or the RB set may be (pre)configured for sidelink transmission in shared spectrum. A WTRU may perform the LBT sensing over a bandwidth. The bandwidth may be a bandwidth of the resource pool and/or the RB set. The WTRU may perform the LBT sensing over the bandwidth and within a LBT sensing slot with a duration. The duration may be, for example, Tₛₗ=9 us.

A WTRU may perform one or more sidelink transmissions within a COT following a successful SL U channel acquisition, e.g., resulting from the WTRU carrying out a SL U channel access and resource selection procedure. A COT may be expressed in various ways, such as, for example, a total amount of time for one or more WTRU to perform one or more transmissions following a successful channel acquisition. A transmission gap less than or equal to a certain value (e.g., 25 μs) may be counted as a part of the total amount of time for one or more WTRU to perform one or more transmissions. Alternatively, the COT may be a total amount of time for one or more WTRUs to perform one or more transmissions following a successful channel acquisition plus a budgeted amount of time for some number of transmission gaps, where the amount of time for each (or all) of the transmission gaps is less than or equal to the certain value (e.g., 25 μs). A WTRU may continue transmissions after the transmission gap in the same COT.

A WTRU may be (pre)configured with all symbols for PSSCH/PSCCH transmission within a slot for sidelink communications (“sidelink slot”). Such a sidelink slot may be referred to as a PSSCH/PSCCH slot. A WTRU may perform a PSSCH/PSCCH transmission and/or associated DMRS transmission in a PSSCH/PSCCH slot within a COT. The COT may have been initiated by the WTRU (“an initiated COT”) or may have been initiated by another WTRU and made available to and/or shared by (at least) the WTRU (“a shared COT”).

A WTRU performing a PSSCH/PSCCH transmission in a sidelink slot in a resource pool in an initiated COT and/or a shared COT may be referred as a TX WTRU. A WTRU performing a PSFCH transmission in an initiated COT and/or a shared COT in response to a received PSSCH/PSCCH transmission in the resource pool used by a TX WTRU may be referred as an RX WTRU. The PSSCH/PSCCH transmission by a TX WTRU and corresponding PSFCH transmission by an RX WTRU in a resource pool may be referred as associated PSSCH/PSCCH and PSFCH transmissions and/or corresponding PSSCH/PSCCH and PSFCH transmissions.

A WTRU may perform a PSSCH/PSCCH and/or a PSFCH transmission in an indexed sidelink logical slot and/or an indexed physical slot in a resource pool. A sidelink slot may refer to a sidelink logical slot and/or a physical slot unless otherwise stated.

An RX WTRU may receive a PSSCH/PSCCH transmission in a sidelink slot (e.g., in a resource pool) during a COT. An RX WTRU may receive information indicating to report HARQ information for the received PSSCH/PSCCH transmission. The information indicating to report the HARQ information may be carried in sidelink control information (SCI) associated with the PSSCH/PSCCH transmission (e.g., SCI scheduling the PSSCH/PSCCH transmission). The HARQ information may include HARQ ACK information or HARQ NACK information for (e.g., a transport block (TB) received in) the associated SL PSSCH/PSCCH transmission. Although “transport block(s)” and “TB(s)” are used in embodiments/examples set forth herein (e.g., supra and/or infra), application of the embodiments/examples may use other types/formats of information (e.g., in lieu of, or in addition to, transmission block(s)) and still be consistent with the disclosures herein.

One or more resource allocations and/or one or more formats for PSFCH communications (one or more PSFCH transmissions) may be used, defined, configured and/or determined. A WTRU may be (pre)configured with M RB interlaces for PSFCH transmissions. The WTRU may be (pre)configured with the M RB interlaces for PSFCH transmissions over a bandwidth of a resource pool and/or an RB set. The M RB interlaces for PSFCH transmissions (each a “PSFCH RB interlace”) may be based on M=10 for 15-kHz SCS and M=5 for 30-kHz, for example. Each PSFCH RB interlace may be indicated by an index m. The index m may be an integer from 0 to M−1, for example. A PSFCH RB interlace denoted by index m may include RBs corresponding to index (m, m+M, m+2×M, m+3×M, . . . , m+N×M) where N may be a total number of RBs of an RB interlace.

In various embodiments, a WTRU may be (pre)configured with a sequence based format for PSFCH transmissions. A WTRU may be (pre)configured with a plurality of sequences for PSFCH transmissions (“PSFCH sequences”), for example. In various embodiments, the PSFCH sequences may include a first PSFCH sequence to indicate a HARQ ACK and a second PSFCH sequence to indicate a HARQ NACK. The WTRU may be (pre)configured to transmit any of the PSFCH sequences (e.g., any of the first PSFCH sequence and second PSFCH sequence) in one or more (e.g., each) PRBs of a PSFCH interlace. The PSFCH interlace may be, for example, (pre)configured in the resource pool used for the associated PSSCH/PSCCH transmission. The same PSFCH sequence may be repeated in two or more (e.g., each) of the PRBs of the PSFCH interlace.

In various embodiments, the PSFCH sequences may include one or more sets of PSFCH sequences. The PSFCH sequences of each set of PSFCH sequences may be different from one another. The sets of PSFCH sequences may include first and second sets of PSFCH sequences, for example. The first set of PSFCH sequences may indicate a HARQ ACK and the second set of PSFCH sequences may indicate a HARQ NACK. In various embodiments, each PSFCH sequence in one or more of the sets of PSFCH sequences may be a cyclic shifted version of a Zadoff Chu (ZC) base sequence. Each sequence in one or more (e.g., each) of the sets of PSFCH sequences for HARQ ACK (e.g., the first set of PSFCH sequences) may be denoted with a cyclic shift index. Each sequence in one or more (e.g., each) of the sets of PSFCH sequences for HARQ NACK (e.g., second set of PSFCH sequences) may be denoted with a cyclic shift index.

In various embodiments, a WTRU may be (pre)configured with a preselected option and/or a default option for a PSFCH sequence (“default PSFCH sequence”) and preselected option and/or a default option for a PSFCH RB interlace (“default PSFCH RB interlace”). A WTRU may be (pre)configured to, and/or may, perform one or more transmissions of the default PSFCH sequence. The WTRU, for example, may be (pre)configured to, and/or may, perform the transmissions of the default PSFCH sequence in one or more PRBs (e.g., each PRB) of the default PSFCH RB interlace. In various embodiments, the WTRU may be (pre)configured to, and/or may, receive one or more HARQ-enabled PSSCH/PSCCH transmissions. The WTRU may be (pre)configured to, and/or may, perform the transmissions of the default PSFCH sequence in connection with (e.g., after, upon, when, based on, responsive to, on condition of, etc.) receiving the HARQ-enabled PSSCH/PSCCH transmissions (e.g., in the PRBs (e.g., each PRB) of the default PSFCH RB interlace).

A WTRU may be (pre)configured to, and/or may, perform one or more transmissions of a PSFCH sequence in one or more PRBs to indicate (e.g., and/or provide information indicating) any of a HARQ ACK and a HARQ NACK corresponding to a received PSSCH/PSCCH transmission (e.g., one or more of the HARQ-enabled PSSCH/PSCCH transmissions). For example, the WTRU may be (pre)configured to, and/or may, perform the transmissions of the PSFCH sequence in the PRBs to indicate (e.g., and/or provide information indicating) any of a HARQ ACK and a HARQ NACK corresponding to a received PSSCH/PSCCH transmission in addition to being (pre)configured to perform, and/or performing, the transmissions of the default PSFCH sequence in (e.g., each of) the PRBs of the default PSFCH RB interlace.

A WTRU may be (pre)configured to, and/or may, receive an SCI of an associated PSSCH/PSCCH transmission, e.g., one or more of the HARQ-enabled PSSCH/PSCCH transmissions. The WTRU may be (pre)configured to, and/or may, receive the PSSCH/PSCCH transmission in one or more of a plurality of logical slots. The SCI may indicate and/or may include information indicating any of a transmission index, an RB interlace assignment, a source ID of a WTRU, a destination ID of the WTRU, etc. One or more of the logical slots (e.g., each logical slot) may have an associated index.

The WTRU may be (pre)configured to, and/or may, determine an index of a PSFCH PRB of one or more of the PRBs that may be transmitted to indicate (e.g., and/or provide information indicating) any of a HARQ ACK and a HARQ NACK corresponding to a received PSSCH/PSCCH transmission. The WTRU may be (pre)configured to, and/or may, determine the index of a PSFCH PRB based on any of the transmission index, the RB interlace assignment, the WTRU source ID, the WTRU destination ID, and one or more indexes of the one or more logical slots in which the associated PSSCH/PSCCH transmission is received. In various embodiments, the WTRU be (pre)configured to, and/or may, determine that the determined PSFCH PRB and a PRB included in the default PSFCH RB interlace may overlap (e.g., at least partially) in time and/or frequency. The WTRU may be (pre)configured to, and/or may, use a PSFCH sequence other than the default PSFCH sequence (e.g., a PSFCH sequence for/associated with the determined PSFCH PRB), e.g., in connection with (e.g., after, upon, when, based on, responsive to, on condition of, etc.) in a PRB in which the determined PSFCH PRB and the PRB included in the default PSFCH RB interlace may overlap (e.g., at least partially) in time and/or frequency.

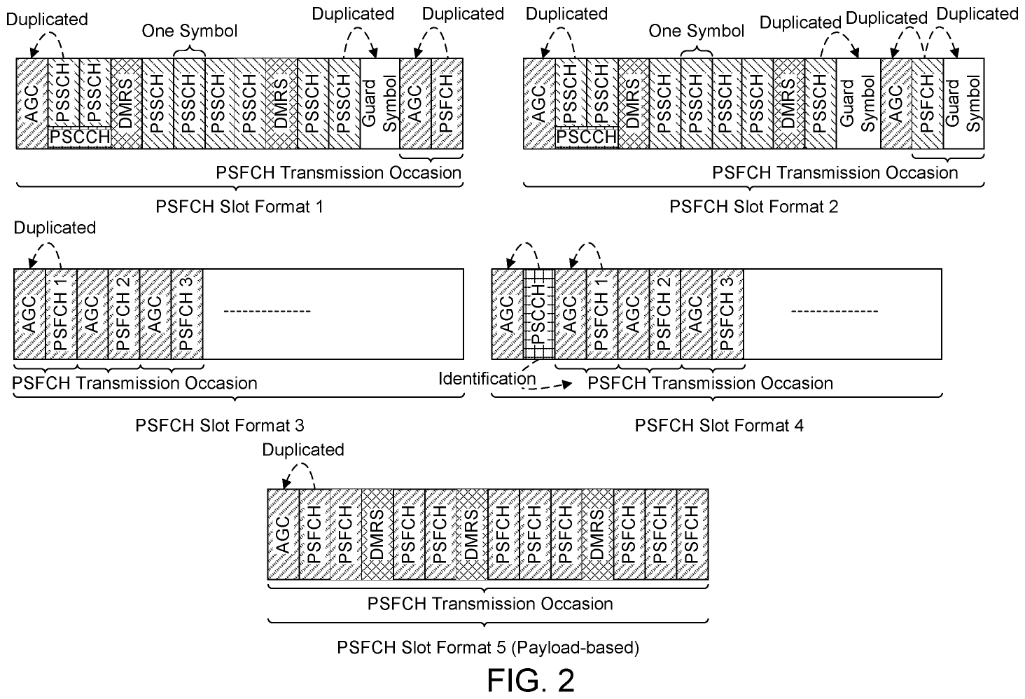

In various embodiments, a WTRU may be (pre)configured with a PSFCH with an information payload of a (pre)configured number of bits, e.g., PSFCH slot format 5 shown in FIG. 2. A WTRU may include one or more HARQ feedback information in the PSFCH.

One or more transmission occasions and/or one or more slots for PSFCH communications (one or more PSFCH transmissions) may be used, defined, configured and/or determined. A WTRU may perform a PSFCH transmission in a transmission occasion (“PSFCH transmission occasion”) in a sidelink slot. A sidelink slot including a PSFCH transmission occasion may be referred to as a PSFCH slot. In various embodiments, a location (e.g., a start (time) and a duration) of a PSFCH transmission occasion within a sidelink slot may be (pre)configured, e.g., in a resource pool. As an example, a PSFCH transmission occasion may be (pre)configured to include a number of consecutive symbols at an end of a PSFCH slot. Alternatively, and/or additionally, a PSFCH transmission occasion may be (pre)configured at a beginning of a PSFCH slot. Alternatively, and/or additionally, a WTRU may be (pre)configured with a starting symbol and number of symbols of a PSFCH transmission occasion within a PSFCH slot. Alternatively, and/or additionally, a PSFCH slot may include symbols (pre)configured for a PSSCH/PSCCH transmission.

A WTRU may be (pre)configured with one or more PSFCH transmission occasion configurations. In various embodiments, the WTRU may be (pre)configured with any of a 2-symbol PSFCH transmission occasion and a 3-symbol PSFCH transmission occasion.

The 2-symbol PSFCH transmission occasion may include two symbols of a PSFCH slot. The two symbols may include a first symbol followed by a second symbol. The first and second symbols may be consecutive or non-consecutive. The second symbol may carry PSFCH content. The first symbol may be (pre)configured as an AGC symbol and may carry a duplicate of the PSFCH content. An RX WTRU may duplicate the PSFCH content to the first (AGC) symbol, may transmit the first (AGC) symbol and may transmit the PSFCH content at the second symbol. The first (AGC) symbol may enable a convergence of AGC for TX WTRU to receive the PSFCH transmission.

The 3-symbol PSFCH transmission occasion may include three symbols of a PSFCH slot. The three symbols may include a first symbol followed by a second symbol followed by a third symbol. The first and second symbols may be consecutive or non-consecutive and the second and third symbols may be consecutive or non-consecutive. The second symbol may carry PSFCH content. The first symbol may be (pre)configured as an AGC symbol and may carry a duplicate of the PSFCH content. The 3^{rd} symbol may be (pre)configured as a guard symbol and may carry a duplicate of the PSFCH content. An RX WTRU may duplicate the PSFCH content to the first (AGC) symbol, may transmit the first (AGC) symbol, and may transmit the PSFCH at the second symbol. The first (AGC) symbol may enable a convergence of AGC for TX WTRU to receive the PSFCH transmission. The RX WTRU may duplicate the 2^{nd} PSFCH symbol to the third (guard) symbol and may transmit the third (guard) symbol. The third (guard) symbol at the end of the PSFCH transmission occasion may allow (e.g., a sufficient amount of time for) a TX WTRU to switch from a reception operation (e.g., for receiving the PSFCH transmission) to a transmission operation for transmitting (e.g., immediately transmitting) a PSSCH/PSCCH transmission in a following (e.g., a next) PSSCH/PSCCH slot in the COT, e.g., to maintain the COT.

In various embodiments, a WTRU may be (pre)configured with one or more of various PSFCH slot formats. FIG. 2 illustrates examples of the various PSFCH slot formats. As shown in FIG. 2, the various PSFCH slot formats may include a first, second, third, fourth and fifth PSFCH slot formats.

The first PSFCH slot format (“PSFCH slot format 1”) may include one or more PSSCH/PSCCH symbols and a 2-symbol PSFCH transmission occasion at an end of a PSFCH slot. The PSFCH slot format 1 may be useful for, and/or may be (pre)configured for, one or more PSFCH transmissions at an end of a COT.

The second PSFCH slot format (“PSFCH slot format 2”) may include one or more PSSCH/PSCCH symbols and a 3-symbol PSFCH transmission occasion at an end of a PSFCH slot. The PSFCH slot format 2 may be useful for, and/or (pre)configured for, one or more PSFCH transmissions within a COT.

The third PSFCH slot format (“PSFCH slot format 3”) may include one or more 2-symbol PSFCH transmission occasions. For example, the PSFCH slot format 3 may include a plurality of consecutive 2-symbol PSFCH transmission occasions. The PSFCH slot format 3 may be useful for, and/or may be (pre)configured for, one or more PSFCH transmissions at a start and/or an end of a COT.

The fourth PSFCH slot format (“PSFCH slot format 4”) may be useful for, and/or may be (pre)configured for, one or more PSFCH transmissions in a PSFCH slot following a PSCCH transmission at a start of the PSFCH slot. The one or more PSFCH transmissions may immediately follow the PSCCH transmission. The PSFCH slot format 4 may include a PSCCH transmission occasion followed by one or more 2-symbol PSFCH transmission occasions. For example, the PSFCH slot format 4 may include the PSCCH transmission occasion followed by a plurality of consecutive 2-symbol PSFCH transmission occasions. The PSCCH transmission occasion may include one or more symbols. As shown, the PSCCH transmission occasion may include first and second symbols. The second symbol may be (pre)configured as an AGC symbol and may carry a duplicate of the PSCCH content. An RX WTRU may duplicate the PSCCH content to the first (AGC) symbol, may transmit the first (AGC) symbol, may transmit the PSCCH at the second symbol and may transmit the plurality of consecutive 2-symbol PSFCH transmission occasions.

The fifth PSFCH slot format (“PSFCH slot format 5”) may include a single slot PSFCH transmission occasion. The PSFCH slot format 5 may be useful for, and/or may be (pre)configured for, one or more PSFCH transmissions at a start and/or an end of a COT.

In various embodiments, a WTRU (pre)configured with PSFCH slot format 1 may be (pre)configured with a guard symbol before a 2-symbol PSFCH transmission occasion in a PSFCH slot. In various embodiments, a WTRU (pre)configured with PSFCH slot format 2 may be (pre)configured with a guard symbol before the 3-symbol PSFCH transmission occasion in a PSFCH slot. A TX WTRU may duplicate the content of a symbol preceding (e.g., immediately preceding) the guard symbol to the guard symbol. For example, in accordance with the PSFCH slot formats 1 and 2 FIG. 2, a TX WTRU may transmit a PSSCH/PSCCH transmission over one or more symbols preceding the PSFCH transmission occasion followed by a guard symbol including duplicate content of one of the symbols (e.g., a last transmitted symbol) carrying the PSSCH/PSCCH content in a PSFCH slot, and in the same slot, an RX WTRU may transmit by one or more PSFCH transmissions during one or more PSFCH transmission occasions. The guard symbol before the PSFCH transmission occasion may allow (e.g., a sufficient amount of time for) the RX WTRU to switch from a reception operation (e.g., for receiving a PSSCH/PSCCH transmission) to a transmission operation for transmitting (e.g., immediately transmitting) a PSFCH transmission during a PSFCH transmission occasion.

A purpose of the transmission of duplicated content during a guard symbol may be to minimize a likelihood of a transmission gap greater than a value (e.g., 25 μs) in a COT so that a TX WTRU may have an opportunity to continue and/or may continue PSSCH/PSCCH transmissions within the COT following a reception of PSFCH transmission.

Reception of PSSCH/PSCCH communications (e.g., one or more PSSCH/PSCCH transmissions) in SL U in a COT by a WTRU may be carried out, used, defined, configured and/or determined. An RX WTRU may receive one or more PSSCH/PSCCH transmissions within a COT from one or more TX WTRUs. The RX WTRU may receive SCI associated with the PSSCH/PSCCH transmissions (e.g., SCI scheduling the PSSCH/PSCCH transmissions). The SCI may include information indicating parameters associated with and/or pertaining to channel access and/or resource determination for the associated PSFCH transmissions. That information may include, for example, any of the following.
A layer 1 (L1) priority assigned to a TB carried in the PSSCH transmission.
A cast type (e.g., unicast, groupcast and/or broadcast) of the TB.
A WTRU source identifier (ID) associated with the PSSCH/PSCCH and associated PSFCH transmission.
A WTRU destination ID associated with the PSSCH/PSCCH and the associated PSFCH transmission.
A WTRU geographic location. A TX WTRU may indicate its geographic location in this indication. As an example, the value of the indication may be a zone ID of the TX WTRU.
A minimum communication range (MCR) parameter or requirement of a TB transmitted in the PSSCH. A TX WTRU may include an index corresponding to a (pre)configured MCR parameter or requirement in unit of meters. An RX WTRU may be (pre)configured to perform sidelink HARQ reporting for a received TB when a determined geographic distance between the RX WTRU and the TX WTRU that may transmit the TB may be less than or equal to the indicated MCR parameter or requirement.
A COT duration indication. A TX WTRU may indicate a remaining time of a COT, for example. The time remaining may be measured from between the sidelink slot in which the SCI may be received and an end of the acquired COT. The time unit of the COT duration indication may be milli-seconds, for example. Alternatively, the time unit may be a sidelink logical slot of the resource pool used for the PSSCH/PSCCH transmission carrying the decoded SCI and/or a physical slot. A TX WTRU may determine the value of this indication based on a (pre)configured maximum COT (mCOT), e.g., a maximum amount of time allowed for the TX WTRU to transmit upon one successful channel access. A TX WTRU may determine a mCOT based on and/or responsive to an L1 priority of TB(s) for PSSCH/PSCCH transmissions within the COT.
A remaining COT duration and/or transmission indication. A TX WTRU may indicate a number of remaining sidelink slots scheduled for PSCCH/PSSCH transmission(s), for example. A time resource indication value (TRIV) may be used for the remaining COT duration and/or transmission indication. The TRIV may be based on and/or responsive to a number of contiguous sidelink slots scheduled for PSCCH/PSSCH transmission(s) in the remaining COT duration.
Alternatively, and/or additionally, the TRIV may be computed jointly based on and/or responsive to a COT duration and a number of scheduled transmissions in the COT. The applied sidelink slot may be a SL logical slot of the resource pool used for the PSSCH/PSCCH transmission and/or a physical slot.
A HARQ transmission index. A TX WTRU may indicate an index in ascending order of the PSSCH/PSCCH transmissions with HARQ feedback enabled in the COT, for example. A TX WTRU may expect a HARQ feedback transmission for each of the PSSCH/PSCCH transmissions. The HARQ transmission index may have n bits and indicate up to 2^{μ} HARQ-enabled PSSCH/PSCCH transmissions within a COT.
A COT index. A TX WTRU may indicate an index in ascending order of a COT including PSSCH/PSCCH transmissions with HARQ feedback enabled, for example. The COT index may have n bits and indicate up to 2ⁿ performed COTs.
A frequency resource assignment. A TX WTRU may indicate one or more RB interlaces and/or an RB set in a resource pool assigned for the PSSCH transmissions in the COT, for example. A TX WTRU may perform transmissions of one or more TBs within a COT using the same frequency resources and may indicate the frequency resource assignment in the SCI in each PSSCH/PSCCH transmission. Alternatively, and/or additionally, a TX WTRU may perform transmissions of one or more TBs within a COT using different frequency resources and may indicate the frequency resource assignment of next n contiguous PSSCH/PSCCH transmissions. The value of n may be (pre)configured in a resource pool. A frequency resource indication value (FRIV) value may be used for the indication, e.g., a TX WTRU may compute a FRIV value based on a starting RB interlace and a number of RB interlaces used for the PSSCH transmission in each slot within the COT.
A COT sharing for PSSCH/PSCCH indication. A TX WTRU may indicate whether a COT may be shared by another WTRU to perform one or more PSSCH/PSCCH transmissions within the COT, for example. The COT sharing for PSSCH/PSCCH indication may be, e.g., a sharing Enabled/Disabled indication. When a sharable COT for PSSCH/PSCCH transmissions may be indicated, unoccupied resources in the COT, e.g., the sidelink slots not scheduled for PSSCH/PSCCH transmission and frequency resources (RBs and/or interlaces) not assigned for the scheduled PSSCH/PSCCH transmissions, may be used for PSSCH/PSCCH transmissions by another WTRU.
A COT sharing for PSFCH indication. In various embodiments, a TX WTRU may indicate whether a COT may be shared by an RX WTRU to perform one or more PSFCH transmissions associated with one or more PSSCH/PSCCH transmissions in the COT, for example. The COT sharing for PSFCH indication may be, e.g., a sharing Enabled/Disabled indication. When this indication may be enabled, an RX WTRU may perform a PSFCH transmission in the same COT in which the RX WTRU may receive the associated PSSCH/PSCCH transmission. Alternatively, and/or additionally, a TX WTRU may indicate whether the COT may be shared by an RX WTRU to transmit one or more PSFCH transmissions associated with one or more PSSCH/PSCCH transmission in a previous COT(s) by the same and/or different TX WTRUs.
In various embodiments, a TX WTRU may indicate a HARQ feedback request in this indication to request an RX WTRU to perform one or more PSFCH transmissions associated with one or more PSCCH/PSSCH transmissions received from the same TX WTRU and/or different TX WTRUs in the current COT and/or one or more previous COTs. An RX WTRU may consider such a request as a polling of unsent HARQ information (feedback) and perform PSFCH transmission(s) of all (or at least some) of the unsent HARQ information (feedback).
A PSFCH transmission occasion indication. In various embodiments, a TX WTRU may indicate a (e.g., current) sidelink slot may be a PSFCH slot, for example. The PSFCH transmission occasion indication may indicate a presence of a PSFCH transmission occasion in a sidelink slot, such as, e.g., at the end of the slot in which the SCI including this indication may be received. In various embodiments, a TX WTRU may indicate another sidelink slot within the COT may be a PSFCH slot. For example, a TX WTRU may include a sidelink slot index and/or a slot offset (n) in this PSFCH transmission occasion indication. The sidelink slot with the indicated slot index and/or located at n sidelink slots after a current sidelink slot may be a PSFCH slot. In various embodiments, a TX WTRU may indicate a PSFCH transmission occasion configuration including a (pre)configured PSSCH-to-PSFCH offset in the same COT, a last sidelink slot of the same COT, another COT, etc. An indication value may be (pre)configured for each PSFCH transmission occasion configuration.
In various embodiments, a resource pool may be (pre)configured with one or more PSFCH slots (“resource-pool PSFCH slots”) and one or more PSFCH transmission occasion may be (pre)configured using the resource-pool PSFCH slots. For example, the (pre)configured PSFCH transmission occasions (“pool PSFCH transmission occasions”) may map to the resource-pool PSFCH slots in a bijective manner. Alternatively, the (pre)configured pool PSFCH transmission occasions map to respective pluralities of the resource-pool PSFCH slots. For example, the (pre)configured pool PSFCH transmission occasions map to different and/or mutually exclusive pluralities of the resource-pool PSFCH slots.
Some or all of the (pre)configured pool PSFCH transmission occasions may have the same duration as the corresponding PSFCH slots of the resource-pool PSFCH slots. Alternatively, the durations of some or all of the (pre)configured pool PSFCH transmission occasions may be less than durations of the corresponding PSFCH slots and any of which may occur during part of the corresponding resource-pool PSFCH slot.
In various embodiments, the PSFCH transmission occasion indication may indicate (refer to) any of the resource pool, one or more of the resource-pool PSFCH slots, and one or more of the (pre)configured pool PSFCH transmission occasions. In various embodiments, the PSFCH transmission occasion indication may include information indicating (referring to) any of the resource pool, one or more of the resource-pool PSFCH slots, and one or more of the (pre)configured pool PSFCH transmission occasions.
A HARQ latency bound. A TX WTRU may indicate a HARQ latency bound, e.g., a period of time in which an RX WTRU may perform one or more PFSCH transmissions associated with one or more PSSCH/PSCCH transmission in a (e.g., current) sidelink slot. The TX WTRU may determine the HARQ latency bound based on a remaining packet delay budget (PDB) of a TB carried in the PSSCH transmission. The HARQ latency bound may be expressed in various ways, such as, for example, a number of logical slots. The TX WTRU may monitor for PSFCH transmissions (e.g., expected PSFCH transmissions) within the HARQ latency bound. In various embodiments, the TX WTRU may monitor PSFCH transmissions in one or more (each) of the resource-pool PSFCH slots that occur within (e.g., after the start and prior to the end of) the indicated HARQ latency bound. As used herein, “monitor” and/or “monitoring” may refer to any of detecting, attempting to receive, receive, attempting to decode, decoding, etc. of a transmission, signal, etc. The TX WTRU may flush any HARQ process buffer corresponding to one or more PSFCH transmissions not received during the latency bound.

### Representative Channel Access for PSFCH Communications

Channel access for PSFCH communications (e.g., for one or more PSFCH transmission) in SL U and/or one or more channel access procedures for performing channel access for PSFCH communications in SL U may be carried out, used, defined, configured and/or determined. In various embodiments, an RX WTRU may perform a channel access for PSFCH communications based on COT sharing, i.e., in a shared COT. The terms “channel access” and the terms “channel access procedure” and the like may be used interchangeably herein. Pursuant to the channel access for PSFCH communications based on COT sharing, the RX WTRU may perform one or more PSFCH transmissions in one or more PSFCH transmission occasions in one or more PSFCH slots within a COT. The COT may be the same COT in which the RX WTRU may receive the associated PSSCH transmission from a TX WTRU (e.g., as disclosed herein infra and/or supra). Alternatively, the COT may be different from the one in which the RX WTRU may receive the associated PSSCH/PSCCH transmission from a TX WTRU (e.g., as disclosed herein infra and/or supra).

An RX WTRU may detect a COT. The RX WTRU may determine the COT may be used for PSFCH transmissions associated with PSSCH/PSCCH transmissions received in one or more previous COT(s). The detection and determination may be based on and/or responsive to SCI (e.g., decoded SCI). The COT may be initiated by the same TX WTRU the PSFCH transmissions may be intended for and/or another TX WTRU.

An RX WTRU may perform a LBT sensing in a channel access for PSFCH communications based on COT sharing. The RX WTRU may perform the LBT sensing, for example, when there may be a gap within the COT before one or more PSFCH transmissions are to occur.

A WTRU may determine to perform a LBT sensing, e.g., based on a Type 2A LBT channel access following a gap of 25 μs. Alternatively, and/or additionally, a WTRU may determine to perform a LBT sensing, e.g., based on a Type 2B LBT channel access following a gap of 16 μs. Alternatively, and/or additionally, a WTRU may determine to not to perform a LBT sensing, e.g., based on a Type 2C LBT channel access following a gap smaller than 16 μs. In various embodiments, when an RX WTRU may perform one or more PSFCH transmission during a PSFCH transmission occasion with a starting symbol immediately following a last symbol of a PSSCH/PSCCH transmission, the RX WTRU may perform channel access based on a Type 2C LBT channel access, where LBT sensing is not performed before the PSFCH transmission. In various embodiments, when a TX WTRU may perform a PSSCH/PSCCH transmission at a symbol immediately following a last symbol of a received PSFCH transmission at a PSFCH transmission occasion (e.g., in accordance with PSFCH slot format 2), the TX WTRU may perform channel access based on a Type 2C LBT channel access, where LBT sensing is not performed before the PSSCH/PSCCH transmission.

In various embodiments, a WTRU may be (pre)configured to, and/or may, receive a PSFCH transmission at/during a PSFCH occasion. The WTRU may be (pre)configured to, and/or may, perform a PSSCH/PSCCH transmission at a symbol (e.g., immediately) following a last symbol of the received PSFCH transmission at the PSFCH occasion. The WTRU may be (pre)configured to, and/or may, indicate a PSFCH slot format having an unoccupied symbol in at, and/or near, an end of the PSFCH occasion. For example, the WTRU may be (pre)configured to, and/or may, indicate a PSFCH slot format having an unoccupied symbol in at, and/or near, an end of the PSFCH occasion in connection with (e.g., after, upon, when, based on, responsive to, on condition of, etc.) the WTRU performs a PSSCH/PSCCH transmission at the symbol (e.g., immediately) following a last symbol of the received PSFCH transmission at the PSFCH.

In various embodiments, the PSFCH slot format may be (pre)configured. The (pre)configured PSFCH slot format may enable a WTRU to carry out a Type 2A/2B LBT procedure, e.g., in connection with (e.g., prior to) a PSSCH/PSCCH transmission that shares a COT with a preceding (e.g., earlier in time) PSFCH transmission.

In various embodiments, a WTRU may be (pre)configured to, and/or may, perform a PSFCH transmission using the (pre)configured PSFCH slot format and/or may be (pre)configured to, and/or may, forego performing (e.g., might not perform) a transmission at the last symbol.

In various embodiments, a WTRU may be (pre)configured to, and/or may, perform a PSSCH/PSCCH transmission following the PSFCH transmission in a shared COT and/or may be (pre)configured to, and/or may, perform a (pre)configured Type 2A or Type 2B LBT channel access, e.g., at a start of the last symbol. In various embodiments, a TX WTRU may be (pre)configured to, and/or may, perform a transmission of a channel reservation signal and/or cyclic prefix extension (CPE) until a next slot boundary, e.g., in connection with (e.g., after, upon, when, based on, responsive to, on condition of, etc.) the performed Type 2A or Type 2B LBT channel access being successful. A TX UE may perform a PSSCH/PSCCH transmission at the next slot boundary in the COT.

A WTRU may perform LBT sensing over a bandwidth of the resource pool and/or RB set (e.g., (pre)configured for the PSFCH transmission). An RX WTRU may determine not to use a transmission gap of a shared COT if that transmission gap may be smaller than a first value (e.g., 25 us). The RX WTRU may perform one or more PSFCH transmissions in a transmission gap of a shared COT if that transmission gap may be larger than a second value (e.g., 25 us). The first value and the second value may be the same or different.

In various embodiments, an RX WTRU may perform a channel access for PSFCH communications based on COT initiation, i.e., in an initiated COT. The RX WTRU may initiate a COT for one or more PSFCH transmissions associated with one or more PSSCH/PSCCH transmissions received from one or more TX WTRUs in one or more previous COTs. Alternatively, and/or additionally, an RX WTRU may initiate a COT for one or more PSFCH transmissions and one or more PSSCH/PSCCH transmissions when the RX WTRU may have data in the buffer for transmission. Pursuant to a channel access for PSFCH communications based on COT initiation, an RX WTRU may perform one or more PSFCH transmissions in one or more PSFCH transmission occasions in one or more PSFCH slots within a COT. That COT may be one in which an RX WTRU may initiate to perform one or more PSFCH transmissions and/or one or more PSSCH/PSCCH transmissions (e.g., as disclosed herein infra and/or supra).

A WTRU may perform LBT sensing for COT initiation, e.g., based on a Type 1 channel access, in a set of logical slots (e.g., a set of consecutive logical slots) and over a bandwidth of a resource pool (e.g., (pre)configured for PSFCH transmissions). A WTRU may concurrently perform SCI decoding and may detect from the SCI a sharable COT on which channel access for PSFCH communications based on COT sharing may be carried out. The WTRU may stop COT initiation if the WTRU may detect a sharable COT in which one or more PSFCH transmission may be performed (e.g., based on the channel access for PSFCH communications based on COT sharing).

### Representative Procedures and Mechanisms for Carrying Out PSFCHs Transmissions

PSFCH communications (e.g., one or more PSFCH transmissions) in SL U in a same COT as associated PSSCH/PSCCH communications (e.g., one or more PSSCH/PSCCH transmissions) may be carried out, used, defined, configured and/or determined. An RX WTRU may determine a PSFCH transmission occasion for an associated PSSCH/PSCCH transmission in the same COT based on and/or responsive to any of various criteria, factors and/or other information. The criteria, factors and/or other information may include, for example, any of the following:
a channel access (pre)configuration for PSFCH communications;
a PSSCH-to-PSFCH offset;
an L1 priority associated with PSFCH transmission (e.g., an L1 priority indicated in a SCI of the associated PSSCH/PSCCH transmission);
a PSFCH transmission occasion (pre)configuration;
a COT duration;
remaining transmissions scheduled in the COT; and
a TX WTRU indication.

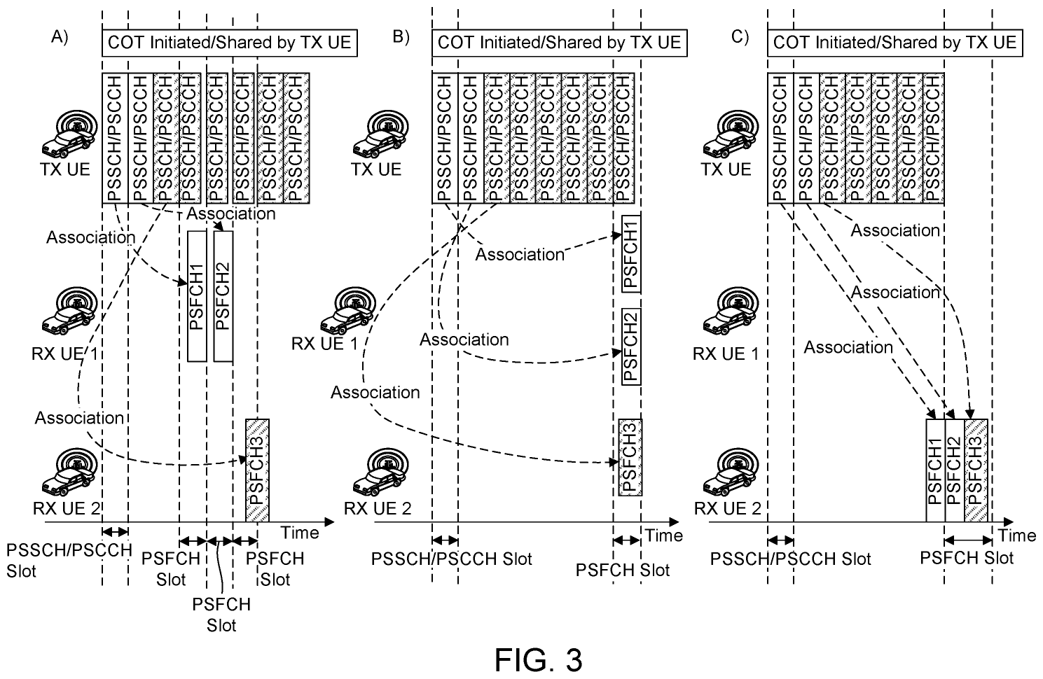

FIG. 3 illustrates examples of PSFCH transmissions and associated PSSCH/PSCCH transmission carried out during a same COT.

A WTRU may be (pre)configured in a resource pool with one or more performing PSFCH transmissions in the same COT in which the RX WTRU may receive one or more associated PSSCH transmissions from a TX WTRU.

In various embodiments, an RX WTRU may determine a PSFCH transmission occasion for an associated PSSCH/PSCCH transmission in the same COT based on and/or response to any of various criteria, factors and/or other information. For example, the RX WTRU may determine a PSFCH transmission occasion for an associated PSSCH/PSCCH transmission in the same COT based on a (pre)configured PSSCH-to-PSFCH offset in unit of logical slots in the resource pool used by the PSSCH/PSCCH transmission. The offset may be based on a minimum processing time period for a PSFCH transmission required to decode a TB in a PSSCH and generate a HARQ feedback carried in the PSFCH transmission. The value of the minimum processing time may depend on WTRU capability, sub-carrier spacing of the resource pool, TB size, MCS configuration, etc.

In various embodiments, when such a PSSCH-to-PSFCH offset may be (pre)configured as n sidelink slots, an RX WTRU may determine a PSFCH transmission occasion may be included in a PSFCH slot, which may be n sidelink slots after the sidelink slot in which the PSSCH/PSSCH transmission may be received. An example for n=2 may be found in A) in FIG. 3.

In various embodiments, an RX WTRU may be (pre)configured with a PSFCH transmission occasion specific to a resource pool, e.g., a number of sidelink slots in a resource pool for a period of PSFCH transmission occasions. The (pre)configured period of PSFCH transmission occasions may be m sidelink slots. There may be one PSFCH transmission occasion (PSFCH slot) every m sidelink slots in the resource pool. An RX WTRU may determine a PSFCH transmission occasion in a first sidelink slot in the COT, which may include a (pre)configured PSFCH transmission occasion and at least PSSCH-to-PSFCH slots after the associated PSSCH/PSCCH transmission.

In various embodiments, an RX WTRU may perform determination of a PSFCH transmission occasion based on PSSCH-to-PSFCH offset and/or resource pool-specific PSFCH transmission occasions when the value of an L1 priority indicated in the associated PSSCH/PSCCH transmission may be below a (pre)configured threshold. A small L1 priority value may indicate a TB with high priority and/or low latency and may require prompt HARQ feedback.

In various embodiments, an RX WTRU may determine which of the various PSFCH slot formats to use based on and/or responsive to any of various criteria, factors and/or other information. For example, RX WTRU may determine which of the various PSFCH slot formats to use based on a relative location of the determined PSFCH slot within the COT. The RX WTRU may determine the relative location based on the indicated COT duration and/or remaining transmissions, e.g., as disclosed supra. When the indicated value of remaining transmissions may be larger than a PSSCH-to-PSFCH offset, the RX WTRU may determine the PSFCH slot may be within the COT and/or may apply PSFCH slot format 2. When the indicated value of remaining transmissions may be equal to the PSSCH-to-PSFCH offset, the RX WTRU may determine the PSFCH slot may be the last sidelink slot of the scheduled transmissions and/or may apply PSFCH slot format 1. When the indicated value of remaining transmissions may be smaller than the PSSCH-to-PSFCH offset, a WTRU may determine the PSFCH slot may be outside the indicated COT duration and/or scheduled PSSCH/PSCCH transmissions and may hold the HARQ ACK information for a PSFCH transmission in a subsequent COT, if any.

In various embodiments, a WTRU may determine to use PSFCH slot format 5 in a determined PSFCH transmission occasion at the beginning and/or end of a COT. The WTRU may determine to use PSFCH slot format 5 in a determined PSFCH transmission occasion at the beginning and/or end of a COT, for example, based on, responsive to and/or conditioned on a reference signal receive power (RSRP) of an associated PSSCH/PSCCH transmission satisfying (e.g., being less than) a (pre)configured threshold. Alternatively, and/or additionally, the WTRU may determine to use PSFCH slot format 5 in a determined PSFCH transmission occasion at the beginning and/or end of a COT based on, responsive to and/or conditioned on a distance between the RX WTRU and TX WTRU satisfying (e.g., being greater than) a (pre)configured threshold. Alternatively, and/or additionally, the WTRU may determine to use PSFCH slot format 5 in a determined PSFCH transmission occasion at the beginning and/or end of a COT based on, responsive to and/or conditioned on a number of HARQ feedback bits satisfying (e.g., being greater than) a (pre)configured threshold.

A single-slot PSFCH transmission may provide larger payload and improve PSFCH coverage and reception. An RX WTRU may determine a distance to a TX WTRU based on geographic location information of the RX WTRU and a Zone ID indicated in SCI of a PSSCH/PSCCH transmission received from the TX WTRU. The geographic location information of the RX WTRU may be based on global navigation satellite system (GNSS) information, for example.

In various embodiments, an RX WTRU may determine a PSFCH transmission occasion for an associated PSSCH/PSCCH transmission in the same COT based on and/or responsive to a (e.g., (pre)configured) COT-specific PSFCH slot within the COT. Such a PSFCH transmission occasion may be (e.g., (pre)configured) at an end, (e.g., a last one or more sidelink slots) of an indicated COT and/or scheduled transmissions in the COT, such as shown in B) and C) in FIG. 3. Alternatively, and/or additionally, an RX WTRU may receive SCI including information (e.g., an information element, an indication, etc.) indicating a PSFCH transmission occasion for the PSSCH/PSCCH transmission may be at an end of the same COT.

In various embodiments, an RX WTRU may perform determination of a PSFCH transmission occasion at the end of the same COT when the value of a L1 priority indicated in the associated PSSCH/PSCCH transmission may exceed a (pre)configured threshold. A large value for L1 priority may indicate a TB with low priority and/or large latency and may be transmitted in the end of COT, e.g., to reduce PSFCH transmission overhead.

An RX WTRU may determine a last sidelink slot of a COT based on and/or responsive to any of various criteria, factors and/or other information. For example, the RX WTRU may determine a last sidelink slot of a COT based on and/or responsive to remaining COT/schedule transmissions information indicated in and/or by a SCI of one or more PSSCH/PSCCH transmissions received in a COT. As an example, when an RX WTRU may receive such indication of m in slot (n) within a COT, the RX WTRU may determine that the last sidelink slot of the remaining COT and/or scheduled transmissions in the COT may be sidelink slot (n+m). The RX WTRU may determine a PSFCH transmission occasion in the sidelink slot (n+m) for PSFCH slot format 1 and/or in sidelink slot (n+m+1) for PSFCH slot format 3 and 4.

In various embodiments, an RX WTRU may determine a PSFCH transmission occasion for an associated PSSCH/PSCCH transmission based on and/or responsive to information indicated in and/or by SCI from the TX WTRU. As an example, information indicated in and/or by SCI from the TX WTRU regarding a location of a PSFCH transmission occasion may include any of:
information indicating the PSFCH transmission occasion may be in the same COT (e.g., based on a PSSCH-to-PSFCH offset);
information indicating the PSFCH transmission occasion may be at an end, e.g., one or more last sidelink slots, of the same COT;
information indicating the PSFCH transmission occasion may be in a different COT with TX WTRU polling; and
information indicating the PSFCH transmission occasion may be in a different COT without TX WTRU polling.

An RX WTRU may determine to multiplex multiple PSFCHs in time domain in the same PSFCH transmission occasion. For example, an RX WTRU may determine to multiplex multiple PSFCHs in time domain in the same PSFCH transmission occasion based on and/or responsive to the RX WTRU determining a PSFCH transmission occasion at an end of a same COT, such as shown in C) of FIG. 3. An RX WTRU may determine a PFSCH transmission occasion in the PSFCH slot, e.g., symbol location, according to the ascending order of transmission index of the associated PSCCH/PSSCH transmission in the COT. An RX WTRU may transmit sequences for HARQ NACK at a determined PSFCH transmission occasion corresponding to a missing transmission index, e.g., due to failing to receive and/or decode SCI of the PSSCH/PSCCH transmission.

In various embodiments, an RX WTRU may determine a collection, group, or set (collectively “set”) of one or more PSFCH transmission occasions for an associated PSSCH/PSCCH transmission. The RX WTRU may determine the set of PSFCH transmission occasions, for example, based on one or more (pre)configured pool PSFCH transmission occasions, a PSSCH-to-PSFCH offset and a HARQ latency bound. By way of example, the RX WTRU may determine to include, as a member (e.g., as an initial member) of the set of PSFCH transmission occasions (“first PSFCH transmission occasion”), one of the (pre)configured pool PSFCH transmission occasions that occurs during a sidelink slot that follows at least an PSSCH-to-PSFCH offset (e.g., in terms of slots) after an associated PSSCH/PSCCH transmission. The determined first PSFCH transmission occasion may be, for example, one of the (pre)configured pool PSFCH transmission occasions, where that (pre)configured pool PSFCH transmission occasion may occur during a sidelink slot that may be at least the PSSCH-to-PSFCH offset after an associated PSSCH/PSCCH transmission. In various embodiments, the sidelink slot may be a next occurring sidelink slot after the PSSCH-to-PSFCH offset, where the PSSCH-to-PSFCH offset begins immediately following or otherwise after (e.g., a slot of) an associated PSSCH/PSCCH transmission. The RX WTRU may determine to include in the set of the PSFCH transmission occasions one or more of the (pre)configured pool PSFCH transmission occasions occurring between the first PSFCH transmission occasion and an end of the HARQ latency bound. For example, the RX WTRU may determine to include in the set of the PSFCH transmission occasions all of the (pre)configured pool PSFCH transmission occasions occurring between the first PSFCH transmission occasion and an end of the HARQ latency bound.

In various embodiments, an RX WTRU may determine that a PSFCH transmission occasion and an associated PSSCH/PSCCH transmission may be within a same COT (or not within a same COT) based on whether the PSFCH transmission occasion is in a PSFCH slot that occurs during the COT. Alternatively, the RX WTRU may determine that a PSFCH transmission occasion and an associated PSSCH/PSCCH transmission may be within a same COT (or not within a same COT) based on whether the PSFCH transmission occasion is in a PSFCH slot that occurs at a time other than during (“outside”) the COT). For example, the RX WTRU may determine that a PSFCH transmission occasion may be within the same COT with an associated PSSCH/PSCCH transmission based on (e.g., when, on a condition that, etc.) a PSFCH slot that includes the PSFCH transmission occasion may be within in a remaining duration of a COT indicated in an SCI of the PSSCH/PSCCH transmission. Alternatively, the RX WTRU may determine that a PSFCH transmission occasion may be outside a COT based on (e.g., when, on a condition that, etc.) the PSFCH transmission occasion occurs during in a PSFCH slot that occurs outside a remaining duration of a COT indicated in a SCI of the PSSCH/PSCCH transmission or outside any other (e.g., earlier) portion of the COT. As another alternative, the RX WTRU may determine that a PSFCH transmission occasion may be outside a COT based on (e.g., when, on a condition that, etc.) a PSFCH slot that include the PSFCH transmission occasion occurs outside a remaining duration of a COT indicated in a SCI of the PSSCH/PSCCH transmission or outside any other (e.g., earlier) portion of the COT. A PSFCH transmission occasion may be outside a COT during which an PSSCH/PSCCH transmission occurs based on (e.g., when, on a condition that, etc.) the PSFCH slot is outside the COT.

In various embodiments, an RX UE may perform a channel access (e.g., an LBT channel access) in connection with (e.g., after, upon, when, based on, responsive to, on condition of, etc.) a PSFCH transmission occasion and associated PSSCH/PSCCH transmissions being (that may be, that may be determined to be, determined that they may be, etc.) within a same COT. For example, the RX WTRU may (i) determine that a PSFCH transmission occasion and an associated PSSCH/PSCCH transmission may be within a same COT based on the PSFCH transmission occasion being in a PSFCH slot that occurs during the COT and (ii) perform a channel access (e.g., a LBT channel access) based on (e.g., responsive to, on a condition of, etc.) that determination.

In various embodiments, an RX UE may perform a Type 2 LBT channel access (e.g., any of a Type 2A channel access, a Type 2B channel access, and a Type 2C channel access (“Type 2A/2B/2C”) when (e.g., on a condition that, etc.) a PSFCH transmission occasion and associated PSSCH/PSCCH transmissions may be within a same COT. For example, the RX WTRU may (i) determine that a PSFCH transmission occasion and an associated PSSCH/PSCCH transmission may be within a same COT based on the PSFCH transmission occasion being in a PSFCH slot that occurs during the COT and (ii) perform the Type 2 LBT channel access (e.g., Type 2A/2B/2C) based on (e.g., responsive to, on a condition of, etc.) that determination.

In various embodiments, the RX WTRU may receive a PSSCH/PSCCH transmission in a first COT and may perform a Type 1 LBT channel access to initiate a second COT when (e.g., on a condition that, etc.) a PSFCH transmission occasion may occur after the first COT). For example, the RX WTRU may (i) determine that a PSFCH transmission occasion may occur after the first COT, e.g., based on the PSFCH transmission occasion being in a PSFCH slot that occurs after the first COT, (ii) perform the Type 1 LBT channel access based on (e.g., responsive to, on a condition of, etc.) that determination to initiate the second COT, and/or (iii) perform a PSFCH transmission during the second COT and the PSFCH transmission occasion (or other PSFCH transmission occasion that may occur during the second COT).

In various embodiments, the RX WTRU may perform a Type 2 LBT channel access (e.g., Type 2A/2B/2C) when (e.g., on a condition that, etc.) the PSFCH transmission occasion may be within a new COT initiated by a TX WTRU transmitting the associated PSSCH/PSCCH transmission. For example, the TX WTRU may request a PSFCH transmission at a PSFCH transmission occasion within the new COT. The TX WTRU, for example, may indicate a HARQ polling in a SCI to request a PSFCH transmission at a PSFCH transmission occasion within the new COT. The RX UE WTRU may perform the Type 2 LBT channel access (e.g., Type 2A/2B/2C) based on (e.g., responsive to, on a condition of, etc.) the HARQ polling in the SCI.

In various embodiments, an RX WTRU may perform a channel access prior to a PSFCH transmission occasion, e.g., one or more PSFCH transmission occasions that may be (that may be determined to be, determined that it may be, etc.) members of the set of the PSFCH transmission occasions (“member PSFCH transmission occasions”). For example, the RX UE WTRU may perform a channel access prior to the first PSFCH transmission occasion and/or any other of the member PSFCH transmission occasions occurring between the first PSFCH transmission occasion and the end of the HARQ latency bound.

In various embodiments, the RX WTRU may fail to access the channel prior to one of a plurality of PSFCH transmission occasions and may perform channel access prior to another (e.g., next in time) PSFCH transmission occasion of the plurality of PSFCH transmission occasions (e.g., between two of the of a plurality of PSFCH transmission occasions). For example, the RX WTRU may fail to access the channel prior to one of the PSFCH transmission occasions that may be (that may be determined to be, determined that it may be, etc.) members of the set of the PSFCH transmission occasions (each “a member PSFCH transmission occasion”), and may perform channel access prior to another one of (e.g., next in time) the member PSFCH transmission occasions.

In various embodiments, an RX WTRU may attempt to access the channel in connection with at least one of the member PSFCH transmission occasions and may fail to access the channel at a time to use the set of PSFCH transmission occasions (e.g., at any time prior to an end of the latest occurring member PSFCH transmission occasion).

In various embodiments, an RX WTRU may perform a channel access and acquire a COT to perform PSSCH/PSCCH transmissions in connection with (e.g., after, upon, when, based on, responsive to, on condition of, etc.) the RX WTRU, e.g., a buffer thereof, having data (that may have data, that may be determined to have data, determined that it may have data, etc.) to send (e.g., data available to send). The RX WTRU may perform a PSFCH transmission at a member PSFCH transmission occasion, which occurs within the COT.

In various embodiments, an RX WTRU may attempt to access the channel in connection with at least one of the member PSFCH transmission occasions to transmit at least some of the data and may fail to access the channel at a time to use the set of PSFCH transmission occasions (e.g., at any time prior to an end of the latest occurring member PSFCH transmission occasion). In various embodiments, the RX WTRU may discard the HARQ status information and data (e.g., flush the HARQ buffer) based on and/or responsive to failing to access the channel within a time period, e.g., at a time to use the set of PSFCH transmission occasions.

In various embodiments, a TX WTRU may monitor for a PSFCH transmission during one or more (e.g., each) of the member PSFCH transmission occasions (e.g., (i.e., during one or more of the first PSFCH transmission occasion and/or the member PSFCH transmission occasions occurring between the first PSFCH transmission occasion and the end of the HARQ latency bound). In various embodiments, the TX UE may fail to receive a PSFCH transmission based on and/or responsive to monitoring for a PSFCH transmission during the member PSFCH transmission occasions (e.g., may fail to receive a PSFCH transmission at any time prior to an end of the latest occurring member PSFCH transmission occasion). The TX UE may fail to receive a PSFCH transmission based on and/or responsive to an RX WTRU failing to access the channel at a time to use the set of PSFCH transmission occasions to send data or for other reasons (such as, channel conditions). In various embodiments, the TX WTRU may perform a re-transmission of the associated PSSCH/PSCCH transmission based on and/or responsive to not receiving a PSFCH transmission during the monitored member PSFCH transmission occasions.

In various embodiments, an RX WTRU may indicate/report channel access failure information, e.g., to higher layers. The channel access failure information may include, for example, information (and/or a cause code, or the like) indicating a failure of the RX WTRU to access the channel, e.g., based on and/or responsive to performing an LBT channel access. The RX WTRU may indicate/report the channel access failure information, for example, based on and/or in connection with failing to access the channel after attempting channel access in connection with a PSFCH transmission occasion. For example, the RX WTRU may indicate/report the channel access failure information based on and/or in connection with failing to access the channel after attempting channel access in connection with a single PSFCH transmission occasion (e.g., a single one of the set of PSFCH transmission occasions). Alternatively, and/or additionally, the RX UE WTRU may indicate/report the channel access failure information based on and/or in connection with failing to access the channel after attempting channel access in connection with more than one PSFCH transmission occasion (e.g., two or more of the set of PSFCH transmission occasions). The channel access failure information may include information indicating, for at least one of the more than one PSFCH transmission occasion, any of an identity, a context and/or details of the corresponding PSFCH transmission occasion. Alternatively, and/or additionally, the RX UE may indicate/report the channel access failure information based on and/or in connection with failing to access the channel at a time to use any of a plurality of PSFCH transmission occasions prior to an end of a HARQ latency bound (e.g., at any time prior to an end of a latest occurring member PSFCH transmission occasion of the set of PSFCH transmission occasions). Alternatively, and/or additionally, the RX UE may indicate/report the channel access failure information based on and/or in connection failing to perform a PSFCH transmission within a time period due to failing to access the channel after a single attempt or more than one attempt (e.g., as disclosed herein). As an example, the RX UE may indicate/report the channel access failure information based on and/or in connection failing to perform a PSFCH transmission due to failing to access the channel at a time to use any of a plurality of PSFCH transmission occasions prior to an end of a HARQ latency bound (e.g., at any time prior to an end of a latest occurring member PSFCH transmission occasion of the set of PSFCH transmission occasions).

An RX WTRU may determine a frequency resource of a PSFCH transmission in a determined PSFCH transmission occasion. In various embodiments, the frequency resources of a PSFCH transmission may be a PSFCH RB interlace denoted by an index of m, e.g., as disclosed supra. An RX WTRU may be (pre)configured with M PSFCH RB interlaces in a resource pool. An RX WTRU may determine such a PSFCH RB interlace index for a PSFCH based on and/or responsive to any of various criteria, factors and/or other information. The criteria, factors and/or other information may include, for example, one or more of:
a HARQ transmission index (e.g., indicated in the SCI of the associated PSSCH/PSCCH transmission);
a SL logical slot index of the associated PSSCH/PSCCH transmission;
one or more index(es) of the one or more RB interlaces used by the associated PSSCH/PSCCH transmission;
a WTRU source ID of a TB carried in the associated PSSCH/PSCCH transmission; and
a WTRU destination ID of a TB carried in the associated PSSCH/PSCCH transmission.

In various embodiments, an RX WTRU may determine a PSFCH RB interlace index by performing a modulo operation of (the HARQ transmission index)MOD(the total number of PSFCH RB interlace). As an example, a SCI may include a n-bit HARQ transmission index indication and a TX WTRU may include up to 2^{μ} HARQ-enabled PSSCH/PSCCH transmissions within a COT. In various embodiments, an RX WTRU may determine a PSFCH RB interlace index by performing a modulo operation of (the index of the logical slot in which the associated PSSCH/PSCCH transmission may be received)MOD(the total number of PSFCH RB interlace). In various embodiments, an RX WTRU may determine a PSFCH RB interlace index based on a (pre)configured mapping between PSSCH/PSCCH and PSFCH RB interlace. When an RX WTRU may perform PSFCH transmissions associated PSSCH/PSCCH transmissions from multiple TX WTRUs, an RX WTRU may determine a PSFCH RB interlace index by performing a modulo operation of (the numeric value of TX WTRU Source and/or Destination ID)MOD(the total number of PSFCH RB interlace).

In various embodiments, a WTRU may be (pre)configured with a sequence-based format for PSFCH communications. A WTRU may be (pre)configured with one or more sets of PSFCH sequences, e.g., a first set of one or more PSFCH sequences to indicate a HARQ ACK and a second set of one or more PSFCH sequences to indicate a HARQ NACK. The PSFCH sequences of each set of PSFCH sequences may be different from one another. A WTRU may determine a sequence (i.e., a cyclic shift (CS) index), from among the one or more (different) PSFCH sequences of the one of the first and second sets, corresponding to the intended HARQ feedback to transmit in a PRB of a PSFCH interlace (e.g., (pre)configured) in the resource pool used for the associated PSSCH/PSCCH transmission.

An RX WTRU may determine to transmit a sequence corresponding to the HARQ reporting information at each RB of the determined PSFCH RB interlace in the determined PSFCH transmission occasion. As disclosed supra, in various embodiments, an RX WTRU may repeat the same sequence (pre)configured to HARQ ACK or HARQ NACK in each RB of the PSFCH RB interlace. In various embodiments, an RX WTRU may transmit a different time-shifted version of the sequence (pre)configured to HARQ ACK or HARQ NACK in one or more RBs (e.g., each of the RBs) of the PSFCH RB interlace.

An RX WTRU may determine to multiplex multiple PSFCHs in frequency domain in the same PSFCH transmission occasion. For example, the RX WTRU may determine to multiplex multiple PSFCHs in frequency domain in the same PSFCH transmission occasion based on and/or responsive to the RX WTRU determining a PSFCH transmission occasion in an end of the same COT, such as shown in B) of FIG. 3.

An RX WTRU may use different PFSCH RB interlace for each PSFCH transmission. The RX WTRU may allocate power (e.g., an equal amount of power) to each PSFCH transmission. The transmit power available for one or more PSFCH transmissions may be 1/n of a total available power, where n may be the number of the one or more PSFCH transmissions that are simultaneously transmitted (in entirety or in part). An RX WTRU may determine to perform such a frequency domain multiplexing based on and/or responsive to any of various criteria, factors and/or other information. For example, the RX WTRU may determine to perform such a frequency domain multiplexing based on, responsive to and/or conditioned on an RSRP of an associated PSSCH/PSCCH transmission satisfying (e.g., being greater than) a (pre)configured threshold. Alternatively, and/or additionally, the RX WTRU may determine to perform the frequency domain multiplexing based on, responsive to and/or conditioned on a distance between the RX WTRU and TX WTRU satisfying (e.g., being less than) a (pre)configured threshold. Alternatively, and/or additionally, the RX WTRU may determine to perform the frequency domain multiplexing based on, responsive to and/or conditioned on a number of HARQ feedback bits satisfying a threshold (e.g., being less than) a (pre)configured threshold.

An RX WTRU may use a same and/or different PFSCH RB interlace for each PSFCH transmission. The power available for a PSFCH transmission may be the same as the total available power and may provide better coverage. An RX WTRU may determine to perform such a time domain multiplexing based on any of various criteria, factors and/or other information. For example, the RX WTRU may determine to perform the time domain multiplexing based on, responsive to and/or conditioned on an RSRP of an associated PSSCH/PSCCH transmission satisfying (e.g., being less than) a (pre)configured threshold. Alternatively, and/or additionally, the RX WTRU may determine to perform the time domain multiplexing based on, responsive to and/or conditioned on a distance between the RX WTRU and TX WTRU satisfying (e.g., being greater than) a (pre)configured threshold. Alternatively, and/or additionally, the RX WTRU may determine to perform the time domain multiplexing based on, responsive to and/or conditioned on a number of HARQ feedback bits satisfying (e.g., being greater than) a (pre)configured threshold.

In various embodiments, an RX WTRU may determine to apply PSFCH slot format 4. For example, an RX WTRU may determine to apply PSFCH slot format 4 based on, responsive to and/or conditioned on the RX WTRU intending to perform and/or performing one or more PSFCH transmissions at an end of a same COT. In various embodiments, the RX WTRU may transmit a PSCCH transmission. The PSCCH transmission may include SCI. The SCI may include information indicating and/or pertaining to the PSFCH transmissions in the same PSFCH slot. For example, the information indicating and/or pertaining to the PSFCH transmissions may include information indicating a transmission index corresponding to each of the PSFCH transmissions.

In various embodiments, PSFCH communications (e.g., one or more PSFCH transmissions) in a same or different COT in which associated PSSCH/PSCCH communications (e.g., one or more PSSCH/PSCCH transmissions) and/or associated re-transmitted communications (e.g., one or more blind re-transmissions) are performed may be carried out, used, defined, configured and/or determined. A WTRU may perform an initial transmission and/or a HARQ re-transmission of a HARQ-enabled TB. The WTRU may perform one or more re-transmissions following the initial transmission and/or the HARQ re-transmission. The re-transmissions may be, for example, a set of one or more re-transmissions and/or a plurality or a set of two or more consecutive re-transmissions. The re-transmissions might not (or need not) be triggered by a non-acknowledgement of a prior transmission (e.g., by a HARQ NACK, reception of a transmission reporting a HARQ NACK, etc.) and may be referred to as blind re-transmissions.

A WTRU may determine to, and/or may, perform blind re-transmissions for an initial transmission (e.g., a HARQ-enabled initial transmission) and/or a HARQ re-transmission based on, according to and/or under one or more of various information, conditions, criteria, parameters, etc. The information, conditions, criteria, parameters, etc. may include any of the following:
the WTRU may have one or more TBs in a buffer for transmission in a COT;
the WTRU may determine to enable PSFCH sharing in the COT, e.g., enabled PSFCH transmission and associated initial PSSCH/PSCCH transmission and/or HARQ re-transmission of the TB in the same COT; and
QoS, e.g., a priority of the TB may satisfy (e.g., may be greater than) a (pre)configured threshold.

In various embodiments, a WTRU may determine a number (K) of blind re-transmissions of a TB to perform in/during a COT. The WTRU, for example, may determine the number (K) of blind re-transmissions corresponding to an initial transmission of the TB. Alternatively, or additionally, the WTRU may determine the number (K) of blind re-transmissions corresponding to a HARQ re-transmission of the TB. The number (K) of blind re-transmissions corresponding to an initial transmission of the TB and the number (K) of blind re-transmissions corresponding to a HARQ re-transmission of the TB may be the same number or may be different numbers. Alternatively, the WTRU may determine the number (K) of blind re-transmissions corresponding to both an initial transmission of the TB and a HARQ re-transmission of the TB.

In various embodiments, a WTRU may receive SCI and a TB of a PSSCH/PSCCH transmission in a COT. The SCI may indicate (e.g., may include information indicating) an availability of PSFCH sharing in the COT (e.g., may indicate PSFCH sharing is available and/or enabled or not enabled in the same COT as the PSSCH/PSCCH transmission of the TB). A WTRU may determine the number (K) of blind re-transmissions of the TB to perform in/during the COT in connection with (e.g., after, upon, when, based on, responsive to, on condition of, etc.) being informed that PSFCH sharing is available/enabled the COT. The number (K) of blind re-transmissions of the TB to perform in/during the COT may be based on, according to and/or under one or more of various information, conditions, criteria, parameters, etc. For example, a WTRU may determine a number (K) of blind re-transmissions of a TB to perform in/during a COT based on, according to and/or under one or more of the following:
a maximum COT (MCOT) duration;
a PSFCH occasion within the COT;
a transmission gap (e.g., (pre)configured transmission gap) between a PSSCH/PSCCH transmission and an associated PSFCH transmission in the COT; and
an amount and/or an availability of (e.g., (pre)configured) PSFCH slots, e.g., PSFCH slot periodicity in a resource pool.

The transmission gap may be (e.g., be expressed as) a duration (e.g., in μs), one or more logical slots, a duration equivalent to one or more logical slots, a fraction or a percentage of a duration of a COT, etc. For example, the transmission gap may be a duration of 25 or less μs, 2 or 3 logical slots, a duration equivalent to 2 or 3 logical slots, two or three fifths of a duration of a COT, etc. The transmission gap may be expressed in various other ways, e.g., as disclosed infra.

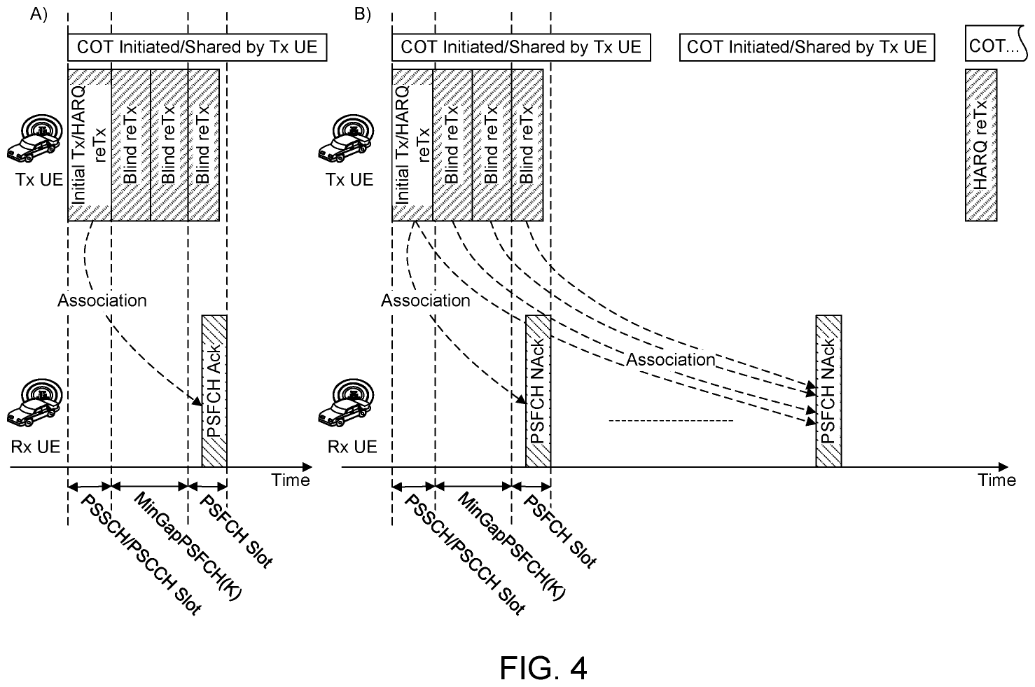

FIGS. 4A-4B illustrate examples of PSFCH transmissions and associated initial transmission and/or blind re-transmissions carried out during a same COT and/or different COTs. FIG. 4A, for example, illustrates examples of initial transmission and blind re-transmissions carried out during a COT along with associated PSFCH transmissions carried out during the same COT. FIG. 4B, for example, illustrates examples of initial transmission and blind re-transmissions carried out during a COT along with associated PSFCH transmissions carried out during the same COT and a different COT (e.g., a later occurring COT).

As shown in FIGS. 4A-4B, a first WTRU (e.g., a Tx WTRU) may perform a PSSCH/PSCCH transmission of a TB (e.g., HARQ-enabled TB) and a second WTRU (e.g., a Rx UE) may perform an PSFCH transmission associated to the PSSCH/PSCCH transmission in/during a COT. The first WTRU (e.g., a Tx WTRU) may perform one or more blind re-transmissions between the PSSCH/PSCCH transmission and the associated PSFCH transmission. The blind re-transmissions have benefits and solve problems in addition to, and/or other than, the conventional benefits and/or problems solved by use of re-transmissions. For example, among the problems solved by the re-transmissions is loss of the COT (and the costs involved with having to undertake processes to initiate a new COT as a result of the loss) that would or might otherwise occur if a transmission gap between the PSSCH/PSCCH transmission and the associated PSFCH transmission satisfies a threshold (e.g., is greater than 25 μs, such as in shared spectrum where a new COT is required when there is a transmission gap of more than 25 μs). The re-transmissions may prevent relinquishing or loss of the COT (and/or prevent another Tx WTRU from acquiring the channel), e.g., by limiting any transmission gap following the PSSCH/PSCCH transmission and prior to the associated PSFCH transmission to a value that satisfies a threshold (e.g., is less than or equal to 25 μs, such as in shared spectrum where a new COT is required when there is a transmission gap of more than 25 μs). The re-transmissions, by preventing relinquishment or loss of the COT (or alternately allowing the COT to be retained), may allow for an RX WTRU to determine/process HARQ ACK/NACK status information and transmit the HARQ ACK/NACK in the associated PSFCH transmission during the COT (wherein the benefit thereof is that the PSCCH/PSSCH transmission and the associated PSFCH transmission share the COT).

In various embodiments, a WTRU may determine a number (K) of blind re-transmissions for an initial transmission of a TB based on (according to, etc.) a transmission gap (e.g., a (pre)configured gap) between a PSSCH/PSCCH transmission and an associated PSFCH transmission in a COT. The transmission gap may be as disclosed supra and/or may be fixed value and/or may account for, or be based on, a (e.g., hypothetical) RX WTRU process time to receive the PSSCH/PSCCH transmission and perform PSFCH transmission carrying the HARQ ACK/NACK information.

In various embodiments, a PSFCH slot including a PSFCH occasion, and a resource may be (pre)configured in a resource pool using a PSFCH slot periodicity, e.g., 1 PSFCH slot every X slots in the resource pool. The number of logical slots in a COT between a PSSCH/PSCCH transmission and an associated PSFCH transmission may vary, e.g., based on (and/or depending on) the PSFCH periodicity and/or a starting logical slot of the COT. A WTRU may determine a number (K) of blind re-transmissions for an initial transmission of a TB based on (according to, etc.) a number of logical slots (e.g., a number equivalent to a total amount of logical slots) between an initial transmission and a PSFCH slot. The WTRU may determine (and/or be informed of) the PSFCH slot. The PSFCH slot may be, for example, an earliest PSFCH slot. The earliest PSFCH slot may be a PSFCH slot that, according to the PSFCH periodicity, occurs first in time following the initial transmission. Alternatively, the earliest PSFCH slot may be a PSFCH slot that, according to the PSFCH periodicity, occurs first in time after (i) the initial transmission and/or (ii) an amount of time. The amount of time may be (pre)configured, and may be based on processing time (e.g., a minimum processing time, a (pre)configured minimum processing time, etc.). The PSFCH slot may be a PSFCH slot occurring after the earliest PSFCH slot, e.g., a next occurring PSFCH slot.

In various embodiments, a WTRU may receive various transmissions (e.g., one or more blind re-transmissions in addition to, or in lieu of, an initial transmission and/or a HARQ re-transmission). The WTRU may determine that the various transmissions may include the blind re-transmissions based on (according to, etc.) one or more of various information, conditions, criteria, parameters, etc. The various information, conditions, criteria, parameters, etc. may include, for example, any of a HARQ process ID, NDI and a RV indicated in an SCI. Alternatively, the various information, conditions, criteria, parameters, etc. may include information, conditions, criteria, parameters, etc. that may be indicated in a SCI of a current transmission pertaining to an upcoming blind re-transmission of a same TB in a same COT, such as, for example:
a transmission index corresponding to (e.g., specific to) the COT of the re-transmission;
an index of a logical slot of the re-transmission; and
a gap, in units of logical slots, between the current transmission and re-transmission

In various embodiments, a TX WTRU may perform an initial transmission of a TB or a HARQ re-transmission of a TB followed by one or more blind re-transmissions of the TB during a COT, e.g., as shown in FIGS. 4A-B. The initial transmission may be, e.g., an initial PSCCH/PSSCH transmission. Although embodiments/examples set forth herein (e.g., supra and/or infra) may include the use of an initial transmission (e.g., an initial PSCCH/PSSCH transmission) or a HARQ re-transmission, application of the embodiments/examples may use another type of transmission (e.g., an initial blind re-transmission) and still be consistent with the disclosures herein. It is also contemplated that other types of transmissions may be used in lieu of, or in addition to, initial transmissions, initial PSCCH/PSSCH transmissions and/or HARQ re-transmissions and still be consistent with the disclosures herein. Further, for simplicity of exposition, the terms “initial transmission(s),” “initial PSCCH/PSSCH transmissions,” “HARQ re-transmission(s)” and the like may be used interchangeably herein. For example, a HARQ re-transmission may be substituted for an initial transmission (and vice versa).

An RX WTRU may receive the initial transmission of the TB. The RX WTRU may determine a HARQ status (e.g., HARQ-ACK or HARQ-NACK) for the initial transmission of the TB, e.g., based on a decoding of the initial transmission. The RX WTRU may perform a PSFCH transmission corresponding to the initial transmission in/during the same COT as the initial transmission of the TB. The PSFCH transmission may report (e.g., indicate and/or include information indicating) the HARQ status.

In various embodiments, the HARQ status may be a HARQ-ACK, e.g., as shown in FIG. 4A). The HARQ-ACK reported in the PSFCH transmission may indicate that the TB may have been received correctly and/or further actions regarding the HARQ status of the TB might not (or need not) be taken. For example, no further reporting of the HARQ status of the transmitted TB by the Rx WTRU and/or no HARQ re-transmission by the Tx WTRU may be carried out (or further reporting of the HARQ status of the transmitted TB by the Rx WTRU and/or HARQ re-transmission by the Tx WTRU might not (or need not) be carried out).

In various embodiments, the HARQ status may be a HARQ-NACK, e.g., as shown in FIG. 4B. The TX WTRU might not (or need not) perform a corresponding HARQ re-transmission in connection with (e.g., after, upon, when, based on, responsive to, on condition of, etc.) the HARQ-NACK being reported in/by the PSFCH transmission. In various embodiments, the RX WTRU may receive one or more of the blind retransmissions of the TB. The RX WTRU may determine a HARQ status (e.g., HARQ-ACK or HARQ-NACK) for the TB, e.g., based on a decoding of the initial transmission and the one or more of the blind retransmissions of the TB. For example, the RX WTRU may combine the decoding results of the received transmissions to improve the reception of the TB. The RX WTRU may perform a PSFCH transmission in the same COT in which the initial transmission and the blind retransmissions are performed or a COT occurring subsequent to the COT in which the initial transmission and the blind retransmissions are performed. For simplicity of exposition herein, the COT in which the initial transmission and the blind retransmissions are performed may be referred to as a “first COT”, the PSFCH transmission occurring during the first COT may be referred to as a “first PSFCH transmission”, the COT occurring subsequent to the first COT may be referred to as a “second COT”, and the PSFCH transmission occurring during the second COT may be referred to as a “second PSFCH transmission.” The second COT may be initiated and/or shared by the RX WTRU (e.g., as shown in FIG. 4B) or by the TX WTRU.

The second PSFCH transmission may report (e.g., indicate and/or include information indicating) the HARQ status. In various embodiments, the HARQ status may be a HARQ-ACK. The HARQ-ACK reported in/by the second PSFCH transmission may indicate that the TB may have been received correctly and/or further actions regarding the HARQ status of the TB might not (or need not) be taken. For example, no further reporting of the HARQ status of the transmitted TB by the Rx WTRU and/or no HARQ re-transmission by the Tx WTRU may be carried out (or further reporting of the HARQ status of the transmitted TB by the Rx WTRU and/or HARQ re-transmission by the Tx WTRU might not (or need not) be carried out).

In various embodiments, the HARQ status may be a HARQ-NACK, e.g., as shown in FIG. 4B. The TX WTRU may perform a corresponding HARQ re-transmission of the TB in connection with (e.g., after, upon, when, based on, responsive to, on condition of, etc.) the HARQ-NACK being reported in/by the second PSFCH transmission. The TX WTRU may perform the corresponding HARQ re-transmission in/during the second COT (the same COT in which the second PSFCH transmission occurs). Alternatively, or additionally, the TX WTRU may perform the corresponding HARQ re-transmission in/during a COT subsequent to the second COT. The COT subsequent to the second COT (“third COT”) may be initiated and/or shared by the TX WTRU (or the RX WTRU).

In various embodiments, the TX WTRU may receive the second PSFCH transmission. The TX WTRU, for example, may receive the second PSFCH transmission performed during the first COT or performed during the second COT. The TX WTRU may receive the second PSFCH transmission during the first COT (e.g., as adjusted by timing advance, etc.) if the second PSFCH transmission is performed during the first COT. Alternatively, TX WTRU may receive the second PSFCH transmission during the second COT (e.g., as adjusted by timing advance, etc.) if the second PSFCH transmission is performed during the second COT.

The TX WTRU may determine that the HARQ status information reported in/by (e.g., indicated by and/or included in) the second PSFCH transmission may correspond to PSSCH/PSCCH transmission(s) of a TB preformed during the first COT, e.g., based on (according to, etc.) one or more of various information, conditions, criteria, parameters, etc. The information, conditions, criteria, parameters, etc. may include, for example, information associated with the TB and indicated in the SCI of the PSSCH/PSCCH transmission, such as one or more of:
a HARQ process ID;
a source ID (e.g., an ID of/associated with the source WTRU (WTRU source ID));
a destination ID (e.g., an ID of/associated with the destination WTRU (WTRU destination ID));
one or more frequency resources (e.g., one or more RB interlace indices);
a transmission index;
a COT index; and
an index of a logical slot in which the transmission of the TB is performed.

In one example, the source ID (e.g., WTRU source ID), the destination ID (e.g., WTRU destination ID), and/or the HARQ process ID may be explicitly indicated in a SCI associated with the PSFCH transmission. In another example, a TX WTRU may perform such a determination based on an implicit association between a PSFCH resource and one or more of the information, conditions, criteria, parameters, etc. (e.g., one or more of the information associated with the TB and indicated in the SCI of the PSSCH/PSCCH transmission). The PSFCH resource may be an index of a PSFCH RB interlace and/or an index of a PRB within a PSFCH RB interlace.

In various embodiments, PSFCH communications (e.g., one or more PSFCH transmissions) and HARQ status communications (e.g., one or more HARQ status transmissions) in a same or different COT in which associated initial communications (e.g., one or more initial transmissions) and/or associated re-transmission communications (e.g., one or more blind re-transmissions) are performed may be carried out, used, defined, configured and/or determined. Each HARQ status transmission (or one or more HARQ status transmissions) of the HARQ status transmissions may include a MAC control element (MAC CE). The MAC CE may include a bitfield. The bitfield may include entries corresponding to initial transmissions and blind retransmissions, e.g., entries corresponding to an initial transmission of a TB and corresponding blind retransmissions of that TB in a COT.

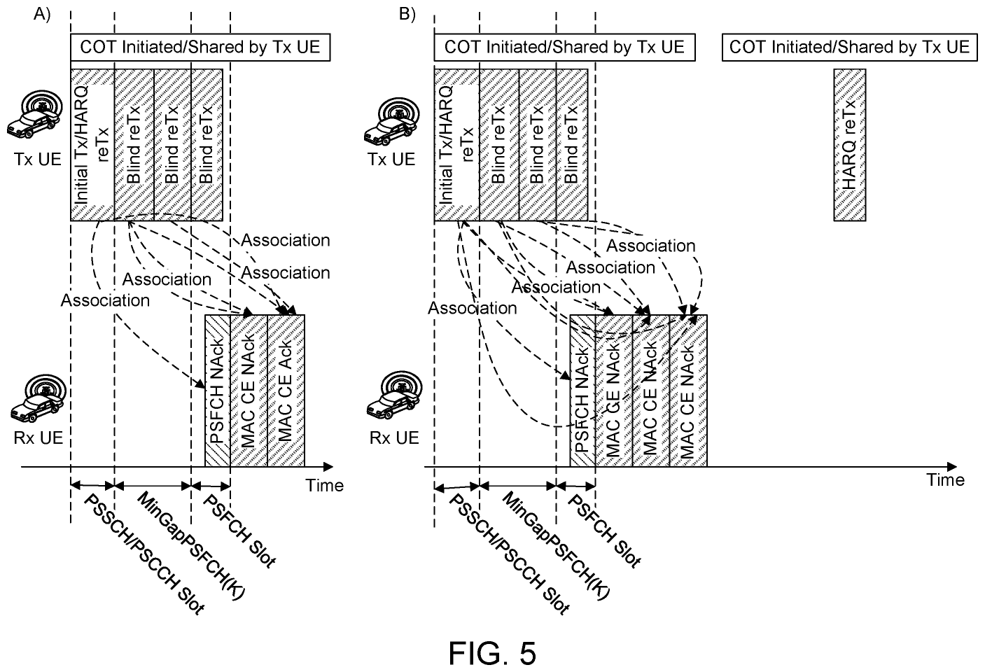

FIGS. 5A-B illustrate examples of initial transmissions and blind re-transmissions along with associated PSFCH transmissions and associated hybrid automatic repeat request (HARQ) status transmissions carried out during a COT. As shown in FIGS. 5A-B (and FIGS. 4A-B), a first WTRU (e.g., a Tx WTRU) may perform an initial transmission of a TB (e.g., HARQ-enabled TB) The first WTRU (e.g., a Tx WTRU) may perform one or more blind re-transmissions between the initial transmission and the associated PSFCH transmission. The blind re-transmissions have benefits and solve problems in addition to, and/or other than, the conventional benefits and/or problems solved by use of re-transmissions. The benefits and/or the problems solved by use of the blind re-transmissions include those disclosed herein (e.g., disclosed infra).

In various embodiments, the RX WTRU may receive the initial transmission of the TB. The RX WTRU may determine a HARQ status (e.g., HARQ-ACK or HARQ-NACK) for the initial transmission of the TB, e.g., based on a decoding of the initial transmission. The RX WTRU may perform the PSFCH transmission to report (e.g., indicate and/or include information indicating) the HARQ status.

In various embodiments, the HARQ status may be a HARQ-ACK. The HARQ-ACK reported in the PSFCH transmission may indicate that the TB may have been received correctly and/or further actions regarding the HARQ status of the TB might not (or need not) be taken. For example, no further reporting of the HARQ status of the transmitted TB by the Rx WTRU and/or no HARQ re-transmission by the Tx WTRU may be carried out (or further reporting of the HARQ status of the transmitted TB by the Rx WTRU and/or HARQ re-transmission by the Tx WTRU might not (or need not) be carried out).

In various embodiments, the HARQ status may be a HARQ-NACK, e.g., as shown in FIGS. 5A-B. The TX WTRU might not (or need not) perform a corresponding HARQ re-transmission in connection with (e.g., after, upon, when, based on, responsive to, on condition of, etc.) the HARQ-NACK being reported in/by the PSFCH transmission. In various embodiments, the RX WTRU may receive one or more of the blind retransmissions of the TB. The RX WTRU may determine a HARQ status (e.g., HARQ-ACK or HARQ-NACK) for the TB, e.g., based on a decoding of the initial transmission and the one or more of the blind retransmissions of the TB. For example, the RX WTRU may combine the decoding results of the received transmissions to improve the reception of the TB.

The Rx WTRU may report HARQ ACK/NACK status using one or more MAC CEs carried in/by one or more PSSCH/PSCCH transmissions performed during the same COT in which the initial transmission and the blind re-transmissions are performed. In this solution, the PSSCH/PSCCH transmissions by RX WTRU may retain the COT, e.g., by performing the PSSCH/PSCCH transmissions such that all transmission gaps following the PSFCH transmission reporting (e.g., indicating and/or including information indicating) the HARQ-ACK and before the PSSCH/PSCCH transmissions (if any) and/or between the PSSCH/PSCCH transmissions (if any) are limited to a value (duration) that satisfies a threshold (e.g., is less than or equal to 25 μs, such as in shared spectrum where a new COT is required when there is a transmission gap of more than 25 μs). A MAC CE for HARQ status information reporting may be enabled and/or disabled based on a (pre)configuration in a resource pool.

In various embodiments, the RX WTRU may include data (e.g., data (buffered and/or available data) intended for the TX WTRU) together with HARQ status information in one or more of the PSSCH/PSCCH transmissions. As an example, the RX WTRU may multiplex (piggyback or otherwise combine) HARQ status information (e.g., one or more of the HARQ status MAC CEs) with data (e.g., data (buffered and/or available data) intended for the TX WTRU), and may include the combination of the HARQ status information and data in one or more of the PSSCH/PSCCH transmissions. Alternatively, the RX WTRU may include the HARQ status information separately from (and together with) the data in one or more of the PSSCH/PSCCH transmissions. The RX WTRU may perform one or more PSSCH/PSCCH transmissions carrying data (e.g., data (buffered and/or available data) intended for the TX WTRU) separate from the PSSCH/PSCCH transmissions carrying the HARQ status information (e.g., in the same COT or a different COT). The PSSCH/PSCCH transmissions may include the HARQ status information without data. The RX WTRU might not (or need not) include data in any of the PSSCH/PSCCH transmissions carrying the HARQ status information (e.g., when all of the data (buffered and/or available data) intended for the TX WTRU was included in one or more of the PSSCH/PSCCH transmissions priorly performed, when there is no data (buffered and/or available data) intended for the TX WTRU, and/or even if data (buffered data) intended for the TX WTRU could be sent). For simplicity of exposition, it is assumed herein that a transmission carrying (including) HARQ status information may refer to a transmission carrying (including) HARQ status information and data (and vice versa).

In various embodiments, the RX WTRU may include data (e.g., data (buffered and/or available data) intended for the TX WTRU) together with one or more of the HARQ status MAC CEs in one or more of the PSSCH/PSCCH transmissions. As an example, the RX WTRU may multiplex (piggyback or otherwise combine) one or more of the HARQ status MAC CEs with data (e.g., data (buffered and/or available data) intended for the TX WTRU), and may include the combination of the one or more HARQ status MAC CEs and data in one or more of the PSSCH/PSCCH transmissions. Alternatively, the RX WTRU may include the one or more HARQ status MAC CEs separately from (and together with) the data in one or more of the PSSCH/PSCCH transmissions. The RX WTRU may perform one or more PSSCH/PSCCH transmissions carrying data (e.g., data (buffered and/or available data) intended for the TX WTRU) separate from the PSSCH/PSCCH transmissions carrying the HARQ status MAC CEs (e.g., in the same COT or a different COT). The PSSCH/PSCCH transmissions may include the HARQ status MAC CEs without data. The RX WTRU might not (or need not) include data in any of the PSSCH/PSCCH transmissions carrying the HARQ status MAC CEs (e.g., when all of the data (buffered and/or available data) intended for the TX WTRU was included in one or more of the PSSCH/PSCCH transmissions priorly performed, when there is no data (buffered and/or available data) intended for the TX WTRU, and/or even if data (buffered data) intended for the TX WTRU could be sent). For simplicity of exposition, it is assumed herein that a transmission carrying (including) one or more HARQ status MAC CEs may refer to a transmission carrying (including) one or more HARQ status MAC CEs and data (and vice versa).

In various embodiments, the PSSCH/PSCCH transmissions carrying the HARQ status MAC CEs may be (or include) two or more successively and/or consecutively performed PSSCH/PSCCH transmissions. The RX WTRU may perform the successive PSSCH/PSCCH transmissions such that all transmission gaps between the successive PSSCH/PSCCH transmissions (or successive and consecutive PSSCH/PSCCH transmissions) are limited to a value (duration) that satisfies a threshold (e.g., is less than or equal to 25 μs, such as in shared spectrum where a new COT is required when there is a transmission gap of more than 25 μs).

In various embodiments, the RX WTRU may determine the HARQ status (e.g., HARQ-ACK or HARQ-NACK) for the TB based on decoding (decoding results of) the initial transmissions and one of blind re-transmissions of the TB. For example, the RX WTRU may determine the HARQ status for the TB based on decoding results of the initial transmission and a blind re-transmission of the blind re-transmissions that the RX WTRU receives first in time (“first blind re-transmission”). The first blind re-transmission may be/correspond to a blind re-transmission of the blind retransmissions that the TX WTRU performs first in time (“first-in-time blind re-transmission”). Alternatively, the first blind re-transmission may be/correspond to a blind re-transmission of the blind retransmissions that the TX WTRU performs after the first-in-time blind re-transmission.

In various embodiments, the RX WTRU may determine the HARQ status (e.g., HARQ-ACK or HARQ-NACK) for the TB based on decoding (decoding results of) the initial transmissions and some of the blind re-transmissions of the TB. For example, the RX WTRU may determine the HARQ status for the TB based on decoding results of the initial transmission, the first blind re-transmission, and/or one or some blind re-transmissions (of the blind re-transmissions) that the RX WTRU receives after the first blind re-transmission (“second blind re-transmission(s)”). The second blind re-transmission(s) may be/correspond to one or some of the blind retransmissions that the TX WTRU performs after the first-in-time blind re-transmission. For example, the second blind re-transmission(s) may be/correspond to one or some of the blind retransmissions that the TX WTRU performs in succession following the first-in-time blind re-transmission.

In various embodiments, the RX WTRU may determine the HARQ status (e.g., HARQ-ACK or HARQ-NACK) for the TB based on decoding (decoding results of) the initial transmissions and all of the blind re-transmissions of the TB that the RX WTRU receives. For example, the RX WTRU may determine the HARQ status for the TB based on decoding results of the initial transmission, the first blind re-transmission, and/or all of the second blind re-transmissions.

In various embodiments, a HARQ status MAC CE (of the HARQ status MAC CE) carried by a (e.g., each) PSSCH/PSCCH transmission (of the PSSCH/PSCCH transmission) may include a single entry or two or more entries that may indicate the HARQ status corresponding to any of (i) an initial transmission and one or more of the blind re-transmissions or (ii) two or more of the blind re-transmissions. For example, a HARQ status MAC CE carried by one of the PSSCH/PSCCH transmissions may include a single entry or two or more entries that may indicate the HARQ status corresponding to any of (i) an initial transmission and a first blind re-transmission, (ii) a first blind re-transmission and a second blind re-transmission, or (iii) two second blind re-transmissions. The HARQ status MAC CE, for example, may include a first entry that may indicate the HARQ status corresponding to an initial transmission and a second entry that may indicate the HARQ status corresponding to a first blind re-transmission. Alternatively, the HARQ status MAC CE may include a first entry that may indicate the HARQ status corresponding to a first blind re-transmission and a second entry that may indicate the HARQ status corresponding to a second blind re-transmission. Alternatively, the HARQ status MAC CE may include a first entry that may indicate the HARQ status corresponding to a first of two second blind re-transmissions and a second entry that may indicate the HARQ status corresponding to a second of the second blind re-transmissions. The HARQ status MAC CE may include (e.g., may also include) one or more fields corresponding to transmissions (e.g., one or more of the blind re-transmissions and/or the initial transmission) for which the HARQ status is not determined and/or reported. Those fields may have null or default entries. The one PSSCH/PSCCH transmission may be the PSSCH/PSCCH transmission of the PSSCH/PSCCH transmission that occurs first in time or a PSSCH/PSCCH transmission that occurs thereafter.

As another example, the HARQ status MAC CE carried by one of the PSSCH/PSCCH transmissions may include a single entry or two or more entries that may indicate the HARQ status corresponding to three or more of (i) an initial transmission, (ii) a first blind re-transmission, and (iii) one or more second blind re-transmissions. For example, the HARQ status MAC CE, for example, may include a first entry that may indicate the HARQ status corresponding to an initial transmission, a second entry that may indicate the HARQ status corresponding to a first blind re-transmission and one or more third entries that may indicate the HARQ status corresponding to one or more second blind re-transmissions. The HARQ status MAC CE carried by one of the PSSCH/PSCCH transmissions may include any of the other permutations/combinations of single and multiple entries that may indicate the HARQ status corresponding to three or more of an initial transmission, a first blind re-transmission and one or more second blind re-transmissions (including, e.g., a single entry or a plurality of entries that may indicate the HARQ status corresponding to three or more second blind re-transmissions). The HARQ status MAC CE may include (e.g., also include) one or more fields corresponding to transmissions (e.g., one or more of the blind re-transmissions and/or the initial transmission) for which HARQ status is not determined and/or reported, and those fields may have null or default entries. The one PSSCH/PSCCH transmission may be the PSSCH/PSCCH transmission of the PSSCH/PSCCH transmission that occurs first in time or a PSSCH/PSCCH transmission that occurs thereafter.

In various embodiments, the RX WTRU may determine the HARQ status of a TB based on (e.g., using) one, some or all of the blind re-transmissions that may occur N logical slots before a logical slot in which one of the PSSCH/PSCCH transmission carrying an associated HARQ status MAC CE may be performed. As an example, the RX WTRU may determine multiple HARQ statuses of a TB (e.g., in connection with performing each of the PSSCH/PSCCH transmission carrying a HARQ status MAC CE), where each successive HARQ status of the multiple HARQ statuses may be determined based on an initial transmission and an increasing number of the blind re-transmissions. The HARQ status MAC CE of a first of the PSSCH/PSCCH transmissions may indicate the HARQ status corresponding to all of the blind re-transmissions occurring N logical slots before the logical slot in which the first of the PSSCH/PSCCH transmissions may be performed, the HARQ status MAC CE of a second of the PSSCH/PSCCH transmissions may indicate the HARQ status corresponding to all of the blind re-transmissions occurring N+1 logical slots before the logical slot in which the second of the PSSCH/PSCCH transmissions may be performed, and so on.

With reference to FIG. 5A, N may be equal to 2. The RX WTRU may determine a first of two HARQ statuses based on combined decoding results of the initial transmission and a first blind re-transmission. The RX WTRU may include the first HARQ status in a first of the PSSCH/PSCCH transmissions. The first HARQ status may be a HARQ-NACK, as shown. The RX WTRU may determine the second to the two HARQ statuses based on combined decoding results of the initial transmission and a first blind re-transmission and a second blind re-transmission. The RX WTRU may include the second HARQ status in a second of the PSSCH/PSCCH transmissions. The second HARQ status may be a HARQ-ACK, as shown. In the example shown in FIG. 5A, the RX WTRU may perform a reporting of HARQ status information derived based on an initial transmission and two of the blind re-transmissions of the TB in/during the same COT. The HARQ-ACK reported in/by the HARQ status MAC CE carried in/by the second PSSCH/PSCCH transmission may indicate that the TB may have been received correctly and/or further actions regarding the HARQ status of the TB might not (or need not) be taken. For example, no further reporting of the HARQ status of the transmitted TB by the Rx WTRU and/or no HARQ re-transmission by the Tx WTRU may be carried out (or further reporting of the HARQ status of the transmitted TB by the Rx WTRU and/or HARQ re-transmission by the Tx WTRU might not (or need not) be carried out).

Although not shown in FIG. 5A (and/or FIG. 5B), the RX WTRU may determine that the HARQ status based on combined decoding results of the initial transmission and a first blind re-transmission may be a HARQ-ACK (e.g., instead of a HARQ-NACK). The RX WTRU may indicate/include the HARQ-ACK in a PSSCH/PSCCH transmission performed (e.g., at a logical slot N+2 after the logical slot in which the first blind re-transmission occurs). The HARQ-ACK reported in/by the HARQ status MAC CE carried in/by the PSSCH/PSCCH transmission may indicate that the TB may have been received correctly and/or further actions regarding the HARQ status of the TB might not (or need not) be taken. For example, no further reporting of the HARQ status of the transmitted TB by the Rx WTRU and/or no HARQ re-transmission by the Tx WTRU may be carried out (or further reporting of the HARQ status of the transmitted TB by the Rx WTRU and/or HARQ re-transmission by the Tx WTRU might not (or need not) be carried out).

Alternatively, the RX WTRU may determine that a first HARQ status based on combined decoding results of the initial transmission and a first blind re-transmission may be a HARQ-ACK and may continue on receiving/processing a second blind re-transmission and/or determining a second HARQ status of the TB based on decoding results of (i) the initial transmission and a second blind re-transmission or (ii) a first blind re-transmission and a second blind re-transmission. The second HARQ status may be a HARQ-ACK. The RX WTRU may indicate/include the second HARQ-ACK in lieu of the first HARQ-ACK in a PSSCH/PSCCH transmission performed (e.g., at a logical slot N+2 after the logical slot in which the first blind re-transmission occurs). Alternatively, the RX WTRU may indicate/include the first HARQ-ACK in a first of the PSSCH/PSCCH transmission performed (e.g., at a logical slot N+2 after the logical slot in which the first blind re-transmission occurs) and may indicate/include the second HARQ-ACK in a second of the PSSCH/PSCCH transmission performed (e.g., at a logical slot N+3 after the logical slot in which the first blind re-transmission occurs). In various embodiments, the first PSSCH/PSCCH transmission may be performed to retain the COT and/or the first HARQ-ACK in the first PSSCH/PSCCH transmission may be ignored by the TX WTRU.

In the example shown in FIG. 5B, the RX WTRU may perform a reporting of HARQ status information derived based on an initial transmission and all of the blind re-transmissions of the TB in the same COT. As shown, a HARQ-NACK may be reported in each HARQ status MAC CE of all PSSCH/PSCCH transmissions. The TX WTRU may perform a HARQ re-transmission in a new COT initiated or shared by the TX WTRU in connection with (e.g., after, upon, when, based on, responsive to, on condition of, etc.) a HARQ-NACK being reported in each HARQ status MAC CE of all PSSCH/PSCCH transmissions. Although FIG. 5B shows three PSSCH/PSCCH transmissions, more or less than three PSSCH/PSCCH transmissions may be performed. In another solution, the TX WTRU may perform HARQ re-transmission during a slot following a last of the PSSCH/PSCCH transmissions carrying the HARQ MAC CEs.

In various embodiments, PSFCH communications (e.g., one or more PSFCH transmissions) in a same or different COT in which associated initial communications (e.g., one or more initial transmissions), associated re-transmission communications (e.g., one or more blind re-transmissions), associated PSSCH/PSCCH communications (e.g., one or more associated PSSCH/PSCCH transmissions), and/or HARQ re-transmission communications (e.g., one or more HARQ re-transmissions) are performed may be carried out, used, defined, configured and/or determined. For example, multiple PSFCH transmissions carrying successive HARQ status information corresponding to combination of initial transmission, blind re-transmissions and/or HARQ re-transmissions may be carried out, used, defined, configured and/or determined.

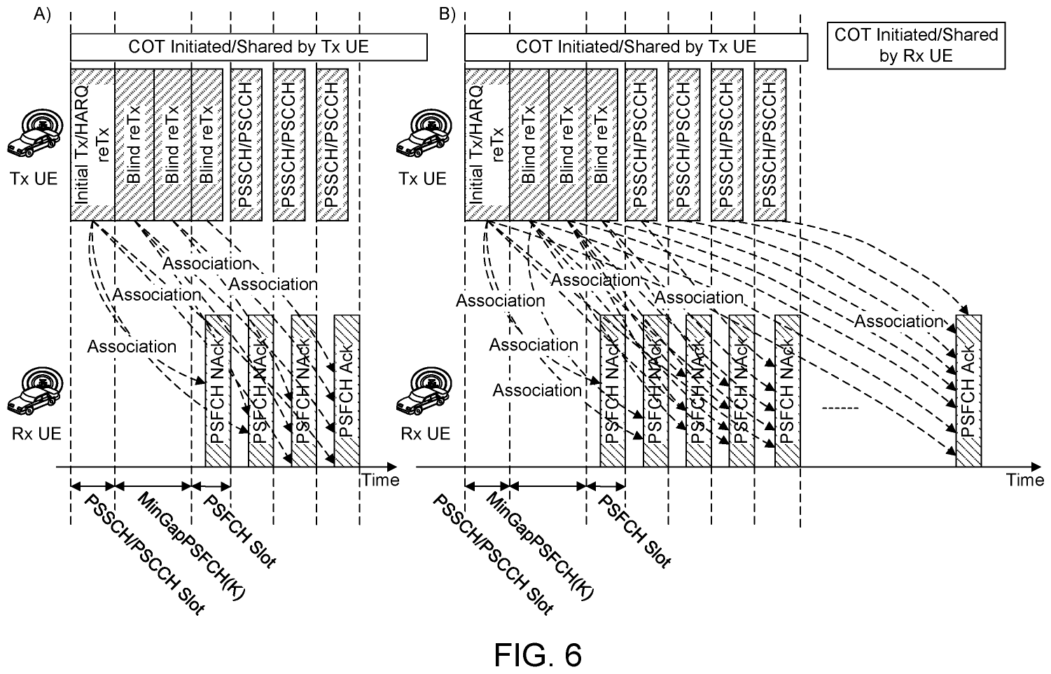

FIGS. 6A-B illustrate examples of initial transmission, blind re-transmissions and PSSCH/PSCCH transmissions along with associated PSFCH transmissions carried out during one or more COTs. FIG. 6A, for example, illustrates examples of initial transmission, blind re-transmissions and PSSCH/PSCCH transmissions carried out during a COT along with associated PSFCH transmissions carried out during the same COT. FIG. 6B, for example, illustrates examples of initial transmission, blind re-transmissions and PSSCH/PSCCH transmissions carried out during a COT along with associated PSFCH transmissions carried out during the same COT and a different COT (a later occurring COT).

In various embodiments, a WTRU may report HARQ ACK/NACK statuses of a TB in multiple PSFCH transmissions performed within a same COT in which associated PSSCH/PSCCH transmissions including the initial transmission, blind re-transmissions and/or HARQ re-transmissions (e.g., as shown in FIG. 6A).

A TX WTRU may determine a number of blind re-transmissions for a TB transmitted an initial transmission (e.g., as disclosed supra) and/or may indicate, e.g., in SCI, to an RX WTRU to perform PSFCH transmission at each PSFCH occasion within the COT. A PSFCH slot, e.g., a slot including PSFCH occasion and resource may be according to a PSFCH slot (pre)configuration in a resource pool. In one example, a PSFCH slot may be (pre)configured with periodicity of one, i.e., each slot may include a PSFCH occasion and resource in a resource pool. In another example, a TX WTRU may indicate, e.g., in SCI, a PSFCH occasion in each slot within the COT. Both examples are reflected in both FIGS. 6A-B.

In various embodiments, a TX WTRU may perform a PSSCH/PSCCH transmission of another TB in the next slot following a reception of PSFCH transmission, e.g., when the TX WTRU has data in the buffer. In various embodiments, a TX WTRU may perform a blind re-transmission and/or HARQ re-transmission in this PSSCH/PSCCH transmission. A TX WTRU may stop the blind-retransmissions in connection with (e.g., after, upon, when, based on, responsive to, on condition of, etc.) a maximum COT duration being reached, and a HARQ-ACK not being received. The TX WTRU may stop the blind-retransmission(s) and/or HARQ re-transmission(s) in connection with (e.g., after, upon, when, based on, responsive to, on condition of, etc.) a HARQ-ACK status being decoded in a received PSFCH transmission.

An RX WTRU may determine one or more blind re-transmission and/or HARQ re-transmission may be associated with a HARQ status information when the blind re-transmission and/or HARQ re-transmission occurs N (e.g., 2) logical slots before the PSFCH slot. An RX WTRU may combine (e.g., perform a combining of) the decoding results of the initial transmission and all determined associated blind re-transmission(s) and/or HARQ re-transmission(s), and may generate a HARQ status of the TB.

The RX WTRU may transmit a first PSFCH including HARQ status information derived based on the initial transmission. In each successive PSFCH transmission, the RX WTRU may report HARQ status information derived based on the combined decoding results of the initial transmission and the blind re-transmissions and/or HARQ re-transmission associated with the PSFCH. The number of transmissions combined for the HARQ status information may increment for each successive PSFCH transmission.

The RX WTRU may report a HARQ NACK in a last PSFCH in a COT. The RX WTRU may perform a PSFCH transmission in a second COT initiated and/or shared by the RX WTRU in connection with (e.g., after, upon, when, based on, responsive to, on condition of, etc.) the HARQ NACK being reported in the last PSFCH in a COT. The HARQ status information included in the PSFCH transmission in the second COT may be derived based on an initial transmission and all blind re-transmission and/or HARQ re-transmissions performed in the first COT.

The TX WTRU may perform a blind re-transmission and/or a HARQ re-transmission in the next slot following a PSFCH transmission. The TX WTRU may perform a Type 2A or Type 2B LBT procedure at the beginning of the last symbol of the PSFCH transmission, e.g., in connection with (e.g., after, upon, when, based on, responsive to, on condition of, etc.) performing a blind re-transmission and/or a HARQ re-transmission in the next slot following a PSFCH transmission. The RX WTRU may not perform transmission at this symbol in accordance with the PSFCH slot format indicated by the TX WTRU in SCI of the associated PSSCH/PSCCH transmission in the COT.

The TX WTRU may perform a transmission of a channel reservation signal and/or a cyclic prefix extension (CPE) between the end of a successful Type 2A or Type 2B LBT procedure and the next slot boundary, e.g., to retain the COT. At the next slot boundary, the TX WTRU may perform a PSSCH/PSCCH blind re-transmission and/or HARQ re-transmission.

PSFCH communications (e.g., one or more PSFCH transmissions) reception in SL U in a same COT as associated PSSCH/PSCCH communications (e.g., one or more PSSCH/PSCCH transmissions) may be carried out, used, defined, configured and/or determined. A TX WTRU may perform determination of PSFCH transmission occasion, PSFCH slot format and PSFCH resource as disclosed supra in connection with an RX WTRU. A TX WTRU may switch from TX to RX during a guard symbol before a PSFCH transmission occasion. A TX WTRU may perform a PSFCH reception using a determined PSFCH resource in a determined PSFCH transmission occasion. When a TX WTRU may receive a PSFCH transmission at the PSFCH transmission occasion within a COT and/or scheduled transmissions, a TX WTRU may switch from RX to TX during the guard symbol at the end of PSFCH transmission occasion and may perform channel access, e.g., channel access based on a Type 2C channel access, and/or may continue PSSCH/PSCCH transmissions scheduled in the COT. When a PSFCH transmission may not be received, a TX WTRU may stop transmissions in the COT and/or may perform another channel access to obtain a new COT for PSSCH/PSCCH transmissions.

In various embodiments, a TX WTRU may perform a Type 2A or Type 2B channel access during a gap in (e.g., an end of) a PSFCH transmission occasion. The gap may be (pre)configured and may have a duration that may be fixed or variable. In various embodiments, the duration of the gap may be, e.g., 16 μs or 25 μs. In various embodiments, the TX UE may continue transmissions in a same COT based on and/or responsive to the channel being determined to be available based on and/or responsive to the Type 2A or Type 2B channel access.

In various embodiments, an initial transmission and one or more HARQ re-transmissions thereof may be configured for, determined for, defined for, used in and/or carried out in a same COT. In various embodiments, one or more HARQ re-transmissions may be configured for, determined for, defined for, used in and/or carried out in a same COT with an initial transmission. In various embodiments, one or more HARQ re-transmissions of an initial transmission may be configured for, determined for, defined for, used in and/or carried out in a same COT with the initial transmission.

In various embodiments, a WTRU may perform an initial PSSCH/PSCCH transmission and one or more corresponding HARQ re-transmissions thereof in a same COT. For example, the WTRU may perform the initial PSSCH/PSCCH transmission and corresponding HARQ re-transmissions a same COT based on non-contiguous transmissions in the same COT.

In various embodiments, a WTRU may perform an initial PSSCH/PSCCH transmission in a COT and may monitor for a corresponding PSFCH in a PSFCH transmission occasion. In various embodiments, the PSFCH transmission occasion within the COT may be indicated in an SCI of the PSSCH/PSCCH transmission. In various embodiments, the PSFCH transmission occasion may be (pre)configured within the COT, e.g., in a sidelink slot that occurs one or more slots (e.g., a (pre)configured a number, X, slots) after the PSSCH/PSCCH transmission.

In various embodiments, a WTRU may receive a PSFCH at a PSFCH transmission occasion in a frequency allocation (e.g., a PRB/PRB interlace/sub-channel). In various embodiments, the WTRU may determine the frequency allocation (“PSFCH frequency allocation”) based on any of a source ID (e.g., WTRU source ID) carried in the PSSCH/PSCCH transmission, a destination ID (e.g., WTRU destination ID) carried in the PSSCH/PSCCH transmission, the frequency allocation used for the PSSCH/PSCCH transmission and/or a slot index of the PSFCH transmission occasion.

In various embodiments, a WTRU may perform a HARQ re-transmission of an earlier transmission in a same COT, e.g., based on and/or responsive to any of various criteria, factors and/or other information. For example, a WTRU may receive and decode a PSFCH transmission, obtain a HARQ NACK of an earlier transmission in a COT based on and/or responsive to the decoding of the received PSFCH transmission, and perform a HARQ re-transmission of an earlier transmission in a same COT based on and/or responsive to the HARQ NACK. Alternatively, and/or additionally, a WTRU may monitor for a PSFCH transmission at one or more PSFCH occasions and perform a HARQ re-transmission of an earlier transmission in a same COT based on and/or responsive to not receiving a PSFCH transmission at the monitored PSFCH transmission occasions. In various embodiments, a WTRU may perform a HARQ re-transmission of an earlier transmission in a same COT based on and/or responsive to (i) the HARQ NACK or not receiving a PSFCH transmission at the monitored PSFCH occasions and (ii) an availability of a channel for performing the HARQ re-transmission.

For example, a WTRU may receive and decode a PSFCH transmission, may obtain a HARQ NACK of an earlier transmission in a COT, and determine the channel may be available between an end of the received PSFCH transmission and a start of the HARQ re-transmission. In various embodiments, the WTRU may perform LBT sensing after (e.g., immediately after) the received PSFCH transmission and determine an availability of the channel (“channel availability”) based on one or more results (e.g., combined results) of the LBT sensing over this period. For example, the WTRU may perform LBT sensing in each sensing slot and determine the channel availability based on the results of one or more (e.g., all) of the sensing slots. In various embodiments, the WTRU determine that the channel may be available (e.g., determine the channel availability indicates the channel may be available) based on and/or responsive to the results of all sensing slots indicating the channel is idle (e.g., the measured RSSI is below a (pre)configured threshold). In various embodiments, a WTRU may perform (e.g., in lieu of or in addition to the LBT sensing) a Type 2 LBT channel access (e.g., a Type 2A LBT channel access) and determine that the channel may be available (e.g., determine the channel availability indicates the channel may be available) immediately or at a certain time before the HARQ re-transmission. For example, the WTRU may perform (e.g., in lieu of or in addition to the LBT sensing) a Type 2 LBT channel access (e.g., a Type 2A LBT channel access) at a time to determine that the channel may be available (e.g., determine the channel availability indicates the channel may be available) immediately or at a certain time before the HARQ re-transmission.

As another example, a WTRU may monitor for a PSFCH transmission at one or more PSFCH transmission occasions, fail to receive a PSFCH transmission at one or more monitored PSFCH occasions, and determine the channel may be available between following the last occurring PSFCH transmission occasion and a start of the HARQ re-transmission. In various embodiments, the WTRU may perform LBT sensing after (e.g., immediately after) last occurring PSFCH transmission occasion and determine channel availability based on one or more results (e.g., combined results) of the LBT sensing over this period. For example, the WTRU may perform LBT sensing in each sensing slot and determine the channel availability based on the results of one or more (e.g., all) of the sensing slots. In various embodiments, the WTRU determine that the channel is available (e.g., determine the channel availability indicates the channel is available) based on and/or responsive to the results of all sensing slots indicating the channel is idle (e.g., the measured RSSI is below a (pre)configured threshold). In various embodiments, a WTRU may perform (e.g., in lieu of or in addition to the LBT sensing) a Type 2 LBT channel access (e.g., a Type 2A LBT channel access) and determine that the channel may be available (e.g., determine the channel availability indicates the channel may be available) immediately or at a certain time before the HARQ re-transmission. For example, the WTRU may perform (e.g., in lieu of or in addition to the LBT sensing) a Type 2 LBT channel access (e.g., a Type 2A LBT channel access) at a time to determine that the channel may be available (e.g., determine the channel availability indicates the channel may be available) immediately or at a certain time before the HARQ re-transmission.

In various embodiments, a WTRU may perform a HARQ re-transmission in a sidelink slot indicated in an SCI of an initial/earlier transmission in a same COT. For example, the SCI of the initial/earlier transmission may include information (e.g., one or more information elements) indicating the sidelink slot. The information may be information indicating a time gap (e.g., an amount of time) between the initial/earlier transmission and the HARQ re-transmission. In various embodiments, the time gap may be a number of logical sidelink slots, for example, and information indicating the time gap may be expressed, for example, in units of logical sidelink slots. In various embodiments, the information indicating the time gap may be an index of the sidelink slot within the COT. In various embodiments, an SCI of a HARQ re-transmission may include a new data indication (NDI), a HARQ process ID and a redundancy version (RV), and a WTRU may set the NDI, HARQ process ID and RV of a HARQ re-transmission accordingly.

In various embodiments, a WTRU may not perform, might not perform or forego performing a HARQ re-transmission based on and/or responsive to any of various criteria, factors and/or other information. In various embodiments, the WTRU may not perform, might not perform or forego performing a HARQ re-transmission of an earlier transmission in a same COT based on and/or responsive to any of the criteria, factors and/or other information. For example, may not perform, might not perform or forego performing a HARQ re-transmission of an earlier transmission in a same COT based on and/or responsive to (i) a HARQ ACK or receiving a PSFCH transmission at monitored PSFCH occasions and/or (ii) a lack of availability of a channel for performing the HARQ re-transmission (e.g., contrary to above). In various embodiments, the WTRU may perform a Type 1 LBT channel access and/or Type 2 LBT channel access to obtain a new COT and perform the HARQ re-transmission in the new COT.

PSFCH communications (e.g., one or more PSFCH transmissions) in SL U in a different COT (e.g., a different and shared COT) than a COT used for associated PSSCH/PSCCH communications (e.g., one or more PSSCH/PSCCH transmissions) may be carried out, used, defined, configured and/or determined. An RX WTRU may determine to perform and/or may perform one or more PSFCH transmissions associated with one or more PSSCH/PSCCH transmissions in a different COT (e.g., a different and shared COT) than a COT used for associated PSSCH/PSCCH transmissions. For example, RX WTRU may determine to perform and/or may perform one or more PSFCH transmissions associated with one or more PSSCH/PSCCH transmissions in a different COT (e.g., a different and shared COT) than a COT used for associated PSSCH/PSCCH transmissions when indicated by, and/or based on and/or responsive to information indicated in one or more transmissions from, a TX WTRU. The information indicated in one or more transmissions from a TX WTRU may indicate, e.g., a duration and/or a remaining portion of the duration of the COT used for associated PSSCH/PSCCH transmissions may is too short as compared to HARQ process time for the one or more PSFCH transmissions (or one or more of the one or more PSFCH transmissions).

An RX WTRU may detect a COT. The RX WTRU may determine that the detected COT may be used for one or more PSFCH transmissions of unsent HARQ feedback information based on and/or responsive to any of various criteria, factors and/or other information. The criteria, factors and/or other information may include any of the following. For example, the RX WTRU may determine that the detected COT may be used for one or more PSFCH transmissions of unsent HARQ feedback information based on and/or responsive to the information in one or more transmissions from a TX WTRU in a COT indicating to send HARQ feedback information intended for the TX WTRU (e.g., as shown in FIG. 4). As an example, a TX WTRU may initiate a COT for one or more PSSCH/PSCCH transmissions and include a HARQ request and/or polling in SCI to one or more RX WTRUs to transmit unsent HARQ feedback information corresponding to the previous one or more PSSCH/PSCCH transmissions from the same TX WTRU.

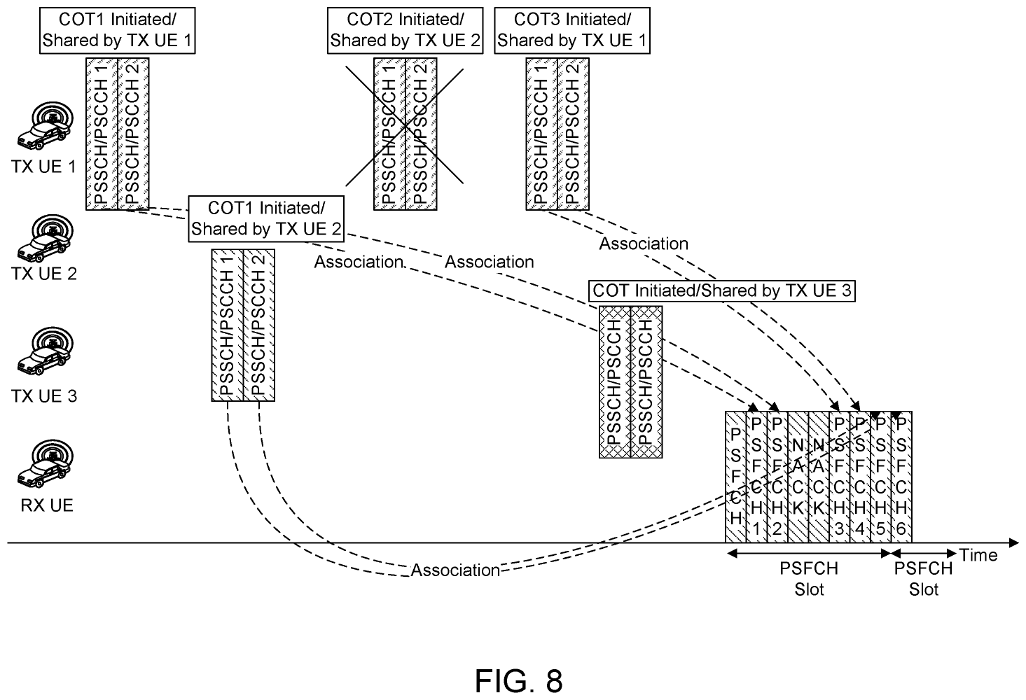

Alternatively, and/or additionally, the RX WTRU may determine that the detected COT may be used for one or more PSFCH transmissions of unsent HARQ feedback information based on, responsive to and/or conditioned on the information in one or more transmissions from a TX WTRU in a COT indicating the COT may be sharable for one or more PSFCH transmissions (e.g., as shown in FIG. 8). As an example, a WTRU may perform PSSCH/PSCCH transmissions with HARQ disabled in an initiated COT and may indicate the remaining COT may be shared for PSFCH transmissions by another WTRU.

When a PSFCH sharing indication may be enabled in a COT, a WTRU may not perform PSSCH/PSCCH sharing with the COT. This may reduce a collision between WTRUs sharing the same COT. An RX WTRU may be (pre)configured to share a COT for PSFCH transmissions, e.g., at an end of the COT and/or scheduled transmission(s). Alternatively, and/or additionally, an RX WTRU may explicitly be indicated in SCI with a PSFCH transmission occasion(s) within and/or at the end of the COT and/or one or more scheduled transmissions.

An RX WTRU may determine to perform and may perform PSFCH transmission for unsent HARQ feedback information in a sharable COT initiated by a TX WTRU for which the HARQ feedback information may not be intended for, e.g., in FIG. 8. In various embodiments, an RX WTRU may determine to share such a COT for PSFCH transmissions when, based on, responsive to and/or on condition that a priority associated with the PSFCH transmissions may satisfy (e.g., is greater than) a (pre)configured threshold.

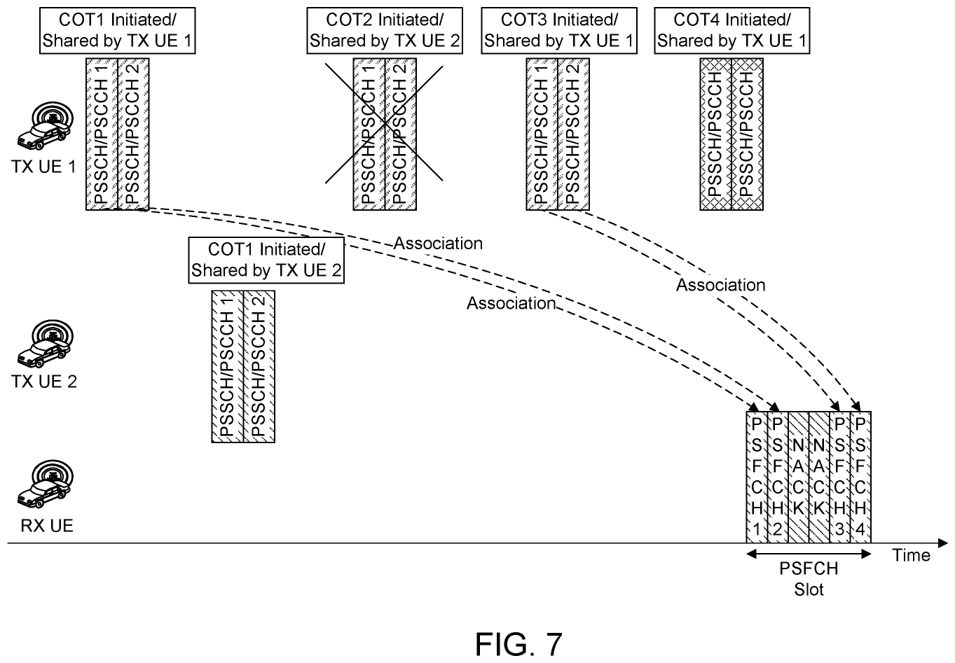

PSFCH transmission occasion and resource for PSFCH communications (e.g., one or more PSFCH transmissions) in SL U may be used, defined, configured and/or determined. An RX WTRU may be indicated in a SCI received in a COT to transmit all or some of unsent HARQ feedback information to the TX WTRU initiating the COT (FIG. 7). An RX WTRU may determine the PSFCH transmission occasions and resources in the COT including the HARQ request based on and/or responsive to any of various criteria, factors and/or other information. The criteria, factors and/or other information may include any of the following.
A number and/or an index of one or more associated COTs An associated COT may be one or more COTs in which an RX WTRU may receive the associated one or more PSSCH/PSCCH transmissions with COT index indicated in SCI of the PSSCH/PSCCH transmissions.
Associated WTRU source and/or destination IDs. The associated WTRU source and/or destination ID may be WTRU source and/or destination IDs indicated in SCI of the associated one or more PSSCH/PSCCH transmissions.
Associated transmission index. The associated transmission index may be the transmission index indicated in SCI of the associated one or more PSSCH/PSCCH transmissions in an associated COT for an associated WTRU source ID and/or WTRU destination ID.

A WTRU may determine the end of a COT and/or scheduled transmissions based on and/or responsive to any of various criteria, factors and/or other information. For example, the WTRU may determine the end of a COT and/or scheduled transmissions based on and/or responsive to an indicated COT duration and/or schedule transmission and/or transmission index. In various embodiments, an RX WTRU may determine a number of PSFCH transmission occasions to be performed in the COT based on, responsive to and/or on condition that the unsent HARQ feedback corresponding to one or more previously received PSSCH/PSCCH transmissions associated with a WTRU source ID and/or WTRU destination ID identical with or corresponding to the WTRU ID(s) indicated in SCI including the HARQ polling request.

A WTRU may determine a set of one or more PSFCH transmission occasions for each associated COT from the TX WTRU according to an ascending order of the associated COT index. An RX WTRU may determine (e.g., set) the one or more PSFCH transmission occasions within each set of one or more PSFCH transmission occasions in ascending order based on and/or responsive to the associated transmission index within the associated COT.

When there may be a missing COT and/or transmission index, e.g., due to the failure of receiving one or more SCIs of one or more of the PSSCH/PSCCH transmissions, an RX WTRU may determine to transmit sequences for HARQ NACK in each PSFCH RB interlace at the PSFCH transmission occasion(s) corresponding to the missing COT and/or transmission index.

FIG. 7 illustrates examples of PSFCH transmissions in a COT based on and/or responsive to TX WTRU polling. Referring to FIG. 7, an RX WTRU may determine to transmit and/or may transmit PSFCH transmissions corresponding to four received PSSCH/PSCCH transmissions when requested by TX WTRU 1 in an initiated COT by TX WTRU 1. Based on the associated COT index and transmission index within each COT, the RX WTRU may determine six PSFCH transmission occasions for TX WTRU 1. In the 3^{rd} and 4^{th} PSFCH transmission occasions, the RX WTRU may transmit a PSFCH transmission for HARQ NACK for the missing (missed) PSSCH/PSCCH transmissions.

An RX WTRU may determine an index of a PSFCH RB interlace for each PSFCH transmission based on the associated WTRU source and/or destination ID, e.g., by (numeric value of the WTRU ID) MOD (total number of pre-configured PSFCH RB interlace). Alternatively, and/or additionally, an RX WTRU may determine an index of PSFCH RB interlace based on (pre)configuration for the PSFCH COT sharing. An RX WTRU may determine the PSFCH sequences to transmit in each RB of the determined PSFCH RB interlace corresponding to the HARQ feedback information, i.e., from a (pre)configure set of PSFCH sequences for HARQ ACK and another set of PSFCH sequences for HARQ NACK, e.g., in accordance with disclosures herein supra and/or infra.

In various embodiments, an RX WTRU may determine one or more PSFCH transmission occasions within a COT based on one or more PSFCH resources, such as one or more PSFCH resources that may be (pre)configured in a resource pool. In various embodiments, a WTRU may determine a frequency allocation of a PSFCH transmission. The frequency allocation of the PSFCH transmission may be one or more RBs, one or more RB interlaces, one or more sub-channels, etc. In various embodiments, the WTRU may determine the frequency allocation of a PSFCH transmission based on a source ID (e.g., WTRU source ID) indicated in an associated PSSCH/PSCCH transmission, a destination ID (e.g., WTRU destination ID) indicated in the associated PSSCH/PSCCH transmission, an associated COT index, a transmission index of the associated PSSCH/PSCCH transmission and/or a frequency allocation (e.g. sub-channel/RB interlace) of the associated PSSCH/PSCCH transmission.

In various embodiments, an RX WTRU may include HARQ feedback information in a PSSCH/PSCCH transmission, e.g., in a MAC CE carried in a PSSCH/PSCCH transmission. In various embodiments, the RX WTRU may include in a PSSCH/PSCCH transmission, e.g., in the MAC CE, information to identify the PSSCH/PSCCH transmission associated with the HARQ feedback information. The information may include, e.g., source ID (e.g., WTRU source ID) indicated in the associated PSSCH/PSCCH transmission, a destination ID (e.g., WTRU destination ID) indicated in the associated PSSCH/PSCCH transmission, the associated COT index, a transmission index of the associated PSSCH/PSCCH transmission and/or a frequency allocation (e.g., sub-channel/RB interlace) of the associated PSSCH/PSCCH transmission.

In various embodiments, an RX WTRU may determine to transmit and/or may transmit one or more PSFCH transmissions using PSFCH slot format 5. An RX WTRU may include an indication of corresponding HARQ feedback information for the requesting TX WTRU. The HARQ feedback information may include a number of HARQ feedbacks corresponding to one or more associated PSSCH/PSCCH transmissions in a (pre)configured order. The order may be based on the associated COT and transmission index, for example. An RX WTRU may indicate HARQ NACK for PSSCH/PSCCH transmissions corresponding to a missing COT and/or transmission index.

A TX WTRU may monitor an end of a COT in which a HARQ request may be sent. A TX WTRU may determine the PSFCH transmission occasions corresponding to expected PSFCH transmissions based on a COT and/or transmission index of associated PSSCH/PSCCH transmissions. A TX WTRU may receive a sequence in a PSFCH RB interlace based on its source and/or destination ID. A TX WTRU may decode a HARQ feedback information in the received PSFCH sequences (e.g., HARQ ACK or NACK sequences) at each PSFCH transmission occasion corresponding to a PSSCH/PSCCH transmission performed in ascending order first in transmission index within a COT and second in COT index.

When an RX WTRU performs PSFCH transmissions in a shared COT initiated by a TX WTRU which the PSFCH transmissions may not be intended for, an RX WTRU may follow the PSFCH transmission occasion and resource determination in accordance with disclosures below.

PSFCH communications (e.g., one or more PSFCH transmissions) in SL U in a COT initiated by an RX WTRU and different from a COT initiate by a TX WTRU and used for associated PSSCH/PSCCH communications (e.g., one or more PSSCH/PSCCH transmissions) may be carried out, used, defined, configured and/or determined. The COT initiated by the RX WTRU may be based on LBT sensing. For example, a WTRU may perform LBT sensing based SL U channel access, e.g., channel access based on a Type 1 LBT channel access, to initiate a COT for one or more PSFCH transmissions. A WTRU may determine a configuration of the LBT sensing based SL U channel access based on and/or responsive to any of various criteria, factors and/or other information, such as, for example, any of:
a resource pool;
one or more RB sets;
a priority associated with the PSFCH transmissions;
a HARQ latency bound;
a number of the PSFCH transmissions to perform in the COT;
a priority of one or more TBs;
a remaining PDB of the one or more TBs;
a number of transmissions of the one or more TBs;
one or more PSFCH resources, e.g., (pre)configured in a resource pool; and
information indicating one or more PSFCH transmission occasions, e.g., information indicating one or more PSFCH transmission occasion received in one or more SCIs of one or more of the associated PSSCH/PSCCH transmissions.

A WTRU may determine to use the bandwidth of a (pre)configured resource pool and/or RB set as the bandwidth of LBT sensing. As an example, the resource pool may be the same as the one used by the associated PSSCH/PSCCH transmission.

A WTRU may determine the duration of the COT for initiation and the size of the contention window based on the priority associated with the PSFCH transmissions, e.g., when, based on, responsive to and/or on condition that the COT for initiation may be used by PSFCH transmissions. The priority associated with the PSFCH transmissions may be a highest priority of the PSSCH/PSCCH transmissions associated with the PSFCH transmissions.

In various embodiments, a WTRU may determine a maximum COT duration and a size of a contention window corresponding to a (pre)configured priority. In various embodiments, an association between a priority and a corresponding maximum COT duration and size of a contention window may be defined in a CAPC configuration. In one example, a (pre)configured priority may be a highest priority, e.g., has a value of 1.

As another example, when a WTRU may have one or more TBs in the buffer for PSSCH/PSCCH transmission and unsent HARQ feedback information, the WTRU may initiate a COT for PSSCH/PSCCH and PSFCH transmissions. A WTRU may determine a duration of such a COT and a size of a contention window based on a highest priority of PSFCH transmissions and the one or more TBs. A WTRU may determine the COT duration based on the number of transmissions of the one or more TBs.

If, during a LBT sensing for COT initiation, a WTRU may detect a sharable COT for one or more PSFCH transmissions, the WTRU may determine to stop the LBT sensing and perform the one or more PSFCH transmissions in the detected sharable COT.

PSFCH transmission occasion and/or resource determination may be carried out, used, defined, configured and/or determined. An RX WTRU may determine PSFCH transmission occasions and/or resources in an initiated COT for one or more PSFCH transmissions, e.g., when a COT may be initiated. The RX WTRU may determine the PSFCH transmission occasions and/or resources in the initiated COT for the one or more PSFCH transmissions based on and/or responsive to any of various criteria, factors and/or other information, such as, for example, any of the following.
A number and/or an index of the associated COT(s). An associate COT may be one or more COT(s) in which an RX WTRU may receive one or more associated PSSCH/PSCCH transmissions with COT index indicated in SCI of the PSSCH/PSCCH transmissions.
Associated WTRU source and/or destination IDs. The associated WTRU source and/or destination IDs may be WTRU source and/or destination IDs indicated in SCI of one or more associated PSSCH/PSCCH transmissions.
An associated transmission index. The associated transmission index may be a transmission index indicated in SCI of one or more associated PSSCH/PSCCH transmissions in an associated COT for an associated WTRU source ID and/or associated WTRU destination ID.

In various embodiments, an RX WTRU may determine a number of PSFCH transmission occasions to be performed in an initiated COT in a PSFCH slot based on the number of unsent HARQ feedback in the buffer.

An RX WTRU may place PSFCH transmissions into groups for different associated WTRU source and/or destination IDs. For each group, a WTRU may determine a set of PSFCH transmission occasions for each associated COT according to an ascending order of the associated COT index. For each set, an RX WTRU may determine a PSFCH transmission occasion over the symbols in ascending order based on the associated transmission index within the associated COT.

When there may be a missing COT and/or transmission index within a COT, e.g., due to the failure of receiving SCI of one or more PSSCH/PSCCH transmissions, an RX WTRU may determine to transmit PSFCH sequences for HARQ NACK in each PSFCH RB interlace at the PSFCH transmission occasion corresponding to the missing COT and/or transmission index.

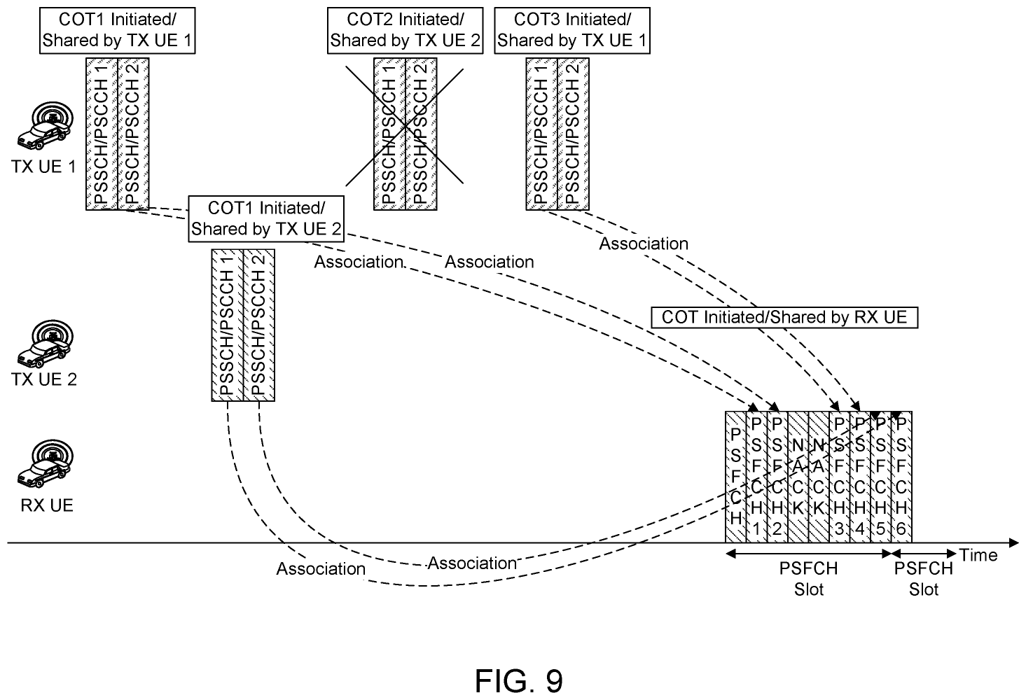

FIG. 9 illustrates example HARQ feedback in an initiated COT for PSFCH transmissions. For example, as shown in FIG. 9, an RX WTRU may determine to transmit one or more PSFCH transmissions corresponding to six received PSSCH/PSCCH transmissions from two TX WTRUs in three different COTs. Based on the associated COT index and transmission index within each COT, the RX WTRU may determine six PSFCH transmission occasions for TX WTRU 1 and two for TX WTRU 2. In the 3^{rd} and 4^{th} PSFCH transmission occasion, the RX WTRU may transmit PSFCH transmissions (e.g., PSFCH sequences) for HARQ NACK for the missing PSSCH/PSCCH transmissions.

An RX WTRU may determine an index of a PSFCH RB interlace for each PSFCH transmission based on the associated WTRU source and/or destination ID, e.g., by (numeric value of the WTRU ID) MOD (total number of pre-configured PSFCH RB interlace). An RX WTRU may determine the PSFCH sequences to transmit in each RB of the determined PSFCH RB interlace corresponding to the HARQ feedback information. The PSFCH sequences may be obtained from a first (pre)configured set of PSFCH sequences for HARQ ACK and a second (pre)configured set PSFCH sequences for HARQ NACK, e.g., in accordance with disclosures herein supra and infra.

In various embodiments, an RX WTRU may determine to transmit and/or may transmit PSFCH transmissions using PSFCH slot format 5. An RX WTRU may include information indicating (e.g., an indication of) source ID and/or destination ID of the TX WTRU and the corresponding HARQ feedback information. Each HARQ feedback information for an indicated TX WTRU may include a number of HARQ feedbacks corresponding to associated PSSCH/PSCCH transmissions in a (pre)configured order based on the associated COT and transmission index. An RX WTRU may indicate HARQ NACK for the PSSCH/PSCCH transmission(s) corresponding to a missing COT and/or transmission index.

PSFCH communication (e.g., one or more PSFCH transmissions) in an initiated COT may be carried out, used, defined, configured and/or determined. In various embodiments, an RX WTRU may transmit a PSSCH transmission prior to transmitting one or more PSFCH transmissions. The PSSCH transmission may include SCI. The SCI may include information pertaining to PSFCH transmissions, e.g., Tx monitoring behavior PSFCH transmission indication and identification information; associated WTRU source and destination ID(s), associated COT index and/or associated transmission index. The Tx monitoring behavior PSFCH transmission indication and identification information may indicate that the transmissions included in the sideling slot may be PSFCH transmissions, and may define a mapping between the WTRU source and/or destination IDs associated with the PSFCH transmissions and the PSFCH transmission occasions with the slot.

Due to LBT uncertainty, an RX WTRU may not have the channel to transmit a PSFCH for an unsend HARQ within the HARQ latency bound indicated for the HARQ process. When the latency bound may expire, an RX WTRU may flush the HARQ process buffer for the unsent HARQ.

When an RX WTRU may have data in the buffer, an RX WTRU may perform both PSSCH/PSCCH and PSFCH transmissions in an initiated COT. As an example, an RX WTRU may apply PSFCH slot format 1 and transmit PSFCHs corresponding to one COT in a PSFCH slot. An RX WTRU may indicate the associated WTRU source and/or destination ID and the associated COT index in the SCI in the PSCCH transmission. As another example, an RX WTRU may apply PSFCH slot format 5 and perform the PSFCH transmissions at the end of the initiated COT.

In various embodiments, a WTRU may perform a Type 1 LBT channel access to initiate a COT so as to include within the duration thereof one or more (pre)configured PSFCH transmission occasions that may occur within a HARQ latency bound. In various embodiments, the HARQ latency bound may be indicated in an SCI of a PSSCH/PSCCH transmission.

In various embodiments, a WTRU may perform one or more PSFCH transmissions carrying various (e.g., all) unsent HARQ feedback information associated with one or more PSSCH/PSCCH transmissions received in one or more same and/or different COTs. In various embodiments, a WTRU may determine a frequency allocation of a PSFCH transmission. The frequency allocation of the PSFCH transmission may be one or more RBs, one or more RB interlaces, one or more sub-channels, etc. In various embodiments, the WTRU may determine the frequency allocation of the PSFCH transmission based on a source ID (e.g., WTRU source ID) indicated in an associated PSSCH/PSCCH transmission, a destination ID (e.g., WTRU destination ID) indicated in the associated PSSCH/PSCCH transmission, an associated COT index, a transmission index of the associated PSSCH/PSCCH transmission and/or a frequency allocation (e.g. sub-channel/RB interlace) of the associated PSSCH/PSCCH transmission.

In various embodiments, a WTRU may include various (e.g., all) unsent HARQ feedback information in a PSSCH/PSCCH transmission, e.g., in a MAC CE carried in a PSSCH/PSCCH transmission. In various embodiments, the WTRU may include in the PSSCH/PSCCH transmission, e.g., in the MAC CE, information to identify the PSSCH/PSCCH transmission associated with the HARQ feedback information. The information may include, e.g., a source ID (e.g., WTRU source ID) indicated in the associated PSSCH/PSCCH transmission, a destination ID (e.g., WTRU destination ID) indicated in the associated PSSCH/PSCCH transmission, an associated COT index, a transmission index of the associated PSSCH/PSCCH transmission and/or a frequency allocation (e.g., sub-channel/RB interlace) of the associated PSSCH/PSCCH transmission.

In various embodiments, a WTRU may construct (generate, determine, and/or the like) the HARQ feedback information, e.g., in a HARQ codebook. In various embodiments, the WTRU may construct (generate, determine, and/or the like) the HARQ feedback information based on the COT index and/or PSSCH/PSCCH transmission index.

Success and/or failure for PSFCH communications (e.g., one or more PFSCH transmission) may be carried out, used, defined, configured and/or determined. An RX WTRU may perform one or more LBT sensing based channel access to initiate a COT to transmit unsent HARQ feedback information. In various embodiments, an RX WTRU may determine a (e.g., LBT) PSFCH channel access failure based on and/or responsive to any of various criteria, factors and/or other information. For example, the RX WTRU may determine a (e.g., LBT) PSFCH channel access failure when, based on, responsive to and/or on condition that the RX WTRU may fail to access the channel within a HARQ latency bound indicated in SCI of a PSSCH/PSCCH transmission by a TX WTRU. Alternatively, and/or additionally, the RX WTRU may determine a (e.g., LBT) PSFCH channel access failure when, based on, responsive to and/or on condition that the RX WTRU may fail to access the channel at a determined PSFCH transmission occasion corresponding to a PSSCH/PSCCH transmission by a WTRU.

An RX WTRU may determine consecutive (e.g., LBT) PSFCH channel access failures when a number of individually determined (e.g., LBT) PSFCH channel access failures may satisfy (e.g., be greater than) a (pre)configured threshold. An RX WTRU may report the consecutive LBT PFSCH channel access failure to higher layers. An RX WTRU may receive a LBT sensing configuration in response to the reported consecutive LBT PSFCH channel access failure. In various embodiments, a CAPC configuration for the received LBT sensing may have a longer contention window.

Monitoring of the PSFCH communications (e.g., one or more transmissions) by a TX WTRU may be carried out, used, defined, configured and/or determined. A TX WTRU may monitor in each sidelink slot a PSFCH transmission within a HARQ latency bound indicated in an associated PSSCH/PSCCH transmission. The TX WTRU may determine the PSFCH transmission occasions associated with its source and/or destination ID corresponding to expected PSFCH transmissions, e.g., based on information in SCI received by the TX WTRU. The TX WTRU may decode a PSFCH transmission at each determined PSFCH transmission occasion within a PSFCH RB interlace based on its source and/or destination ID. The TX WTRU may determine the decoded PSFCH result (e.g., HARQ ACK or NACK sequences) to be the expected HARQ feedback corresponding to a PSSCH/PSCCH transmission performed in ascending order first in transmission index within a COT and second in COT index.

Sharing of a COT initiated for PSFCH transmission may be carried out, used, defined, configured and/or determined.

In various embodiments, a WTRU may monitor a PSFCH transmission during one or more PSFCH transmission occasions indicated in an SCI of an associated PSSCH/PSCCH transmission and may receive the PSFCH transmission. In various embodiments, a WTRU may associate HARQ feedback information in a received PSFCH transmission with a PSSCH/PSCCH transmission based on and/or responsive to any of various criteria, factors and/or other information. For example, the WTRU may associate HARQ feedback information in a received PSFCH transmission with a PSSCH/PSCCH transmission based on and/or responsive to any of (i) an PSFCH transmission occasion (e.g., any of one or more PSFCH transmission occasions indicated in an SCI of an associated PSSCH/PSCCH transmission); (ii) an PSFCH transmission occasion during which the PSFCH transmission is received/sent; (iii) a frequency allocation (e.g., PRB, RB interlace and/or sub-channel) of the PSFCH transmission; (iv) a HARQ process ID, e.g., carried in SCI associated with the PSFCH transmission; (v) a source ID (e.g., WTRU source ID), e.g., indicated in in SCI associated with the PSFCH transmission; and (vi) a destination ID (e.g., WTRU destination ID), e.g., in SCI associated with the PSFCH transmission.

In various embodiments, the HARQ feedback information in (and/or obtained from) the received PSFCH transmission may be a HARQ ACK, and a WTRU may flush a buffer of the associated HARQ process based on and/or responsive to the HARQ ACK (and/or receiving a PSFCH transmission indicating a HARQ ACK). In various embodiments, the HARQ feedback information in (and/or obtained from) a received PSFCH transmission may be a HARQ NACK, and a WTRU may perform a HARQ re-transmission based on and/or responsive to the HARQ NACK (and/or receiving a PSFCH transmission indicating a HARQ NACK).

In various embodiments, a WTRU might not or does not receive a PSFCH transmission at a PSFCH transmission occasion within a same COT with an associated PSSCH/PSCCH transmission and the WTRU may perform a HARQ re-transmission based on or response thereto.

In various embodiments, a WTRU might not or does not receive a PSFCH transmission at a PSFCH transmission occasion after a COT during which an associated PSSCH/PSCCH transmission is received/sent, and the WTRU may not perform, might not perform, or forego performing a HARQ re-transmission and may monitor for a PSFCH transmission at a next PSFCH transmission occasion within the HARQ latency bound.

In various embodiments, a WTRU may receive a HARQ NACK in a PSFCH transmission at a PSFCH transmission occasion in a COT initiated for a PSFCH transmission (“PSFCH COT”). In various embodiments, a WTRU may be (pre)configured with a maximum COT duration for a PSFCH COT.

In various embodiments, a WTRU may perform a HARQ re-transmission in a PSFCH COT, e.g., based on COT sharing information indicated in a SCI associated with the received PSFCH transmission. In various embodiments, a WTRU may be indicated to perform a HARQ re-transmission in a sidelink slot within a PSFCH COT. In various embodiments, the WTRU may perform a Type 2 (e.g., Type 2A or 2B) channel access prior to a start of the sidelink slot. In various embodiments, the channel may be sensed to be available (e.g., determined to be available based on sensing), and the WTRU may perform one or more transmissions of a channel reservation signal and/or a CPE, e.g., until the start of the sidelink slot. In various embodiments, the WTRU may perform a HARQ re-transmission in the sidelink slot.

In various embodiments, a WTRU may be indicated in SCI to perform LBT sensing, between an end of the received PSFCH transmission and a start of the sidelink slot, for HARQ re-transmission (e.g., at one or more times after the end of the received PSFCH transmission and before the start of the sidelink slot). In various embodiments, a WTRU may perform a HARQ re-transmission in the sidelink slot based on and/or responsive to performing LBT sensing in one or more (each of one or more) sensing slots between the end of the received PSFCH transmission and the start of the indicated HARQ re-transmission and the channel is sensed to be idle in one or more (all) of the sensing slots. In various embodiments, the WTRU may perform (e.g., in lieu of or in addition to the LBT sensing) a Type 2 LBT channel access (e.g., a Type 2A/2B LBT channel access) and determine that the channel may be available (e.g., determine the channel availability indicates the channel may be available) immediately or at a certain time before the HARQ re-transmission. For example, the WTRU may perform (e.g., in lieu of or in addition to the LBT sensing) a Type 2 LBT channel access (e.g., a Type 2A LBT channel access) at a time to determine that the channel may be available (e.g., determine the channel availability indicates the channel may be available) immediately or at a certain time before the HARQ re-transmission.

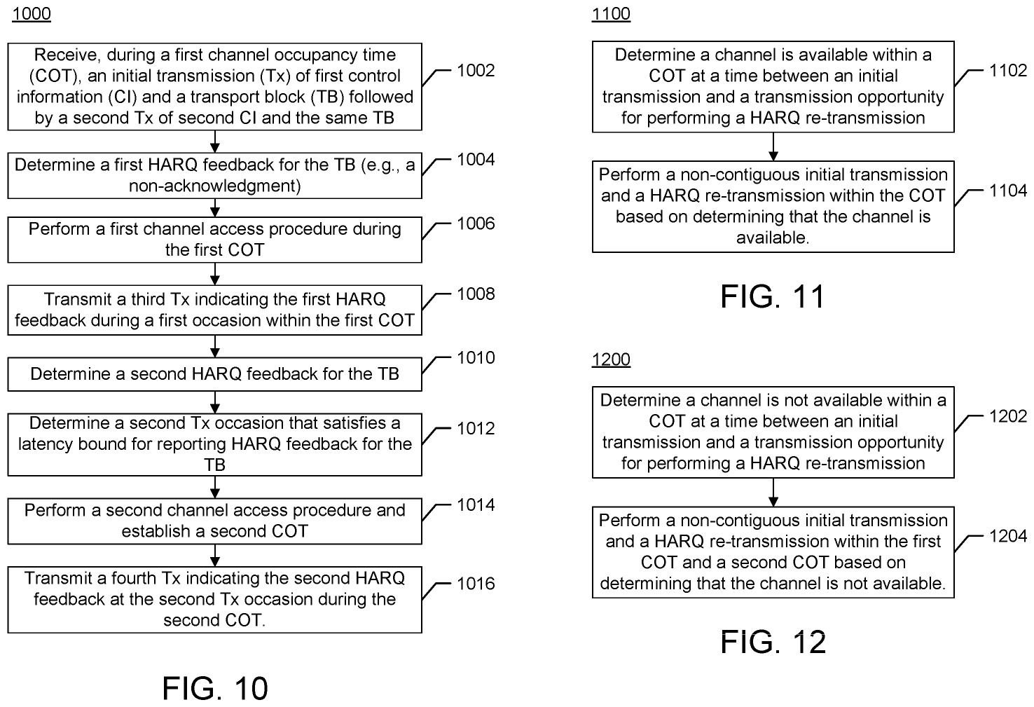

FIG. 10 is a flow chart illustrating an example flow 1000 for carrying out initial transmission and second transmission (e.g., blind re-transmissions) along with associated PSFCH transmissions during one or more COTs. The flow 1000 and accompanying disclosures herein may be considered a generalization of at least some of the disclosures above and are considered to encompass and/or include various embodiments of the disclosures above (e.g., the various embodiments of initial transmission and second transmission (e.g., blind re-transmissions) along with associated PSFCH transmissions during one or more COTs, disclosed herein). The flow 1000 may be carried out using the architecture of the communications system 100 of FIGS. 1A-1D. The flow 1000 may be carried out using other architectures as well.

Referring to FIG. 10, a WTRU may receive, during a first COT established for device-to-device communications, an initial transmission of first control information and a transport block followed by a second transmission of second control information and the same transport block (1002). In various embodiments, at least the first control information indicates a first transmission occasion within the first COT. In various embodiments, at least the second control information indicates a latency bound for reporting HARQ feedback for the transport block.

The WTRU may determine a first HARQ feedback for the transport block (1004). In various embodiments, the first HARQ feedback may be and/or may include a non-acknowledgement.

The WTRU may perform a first channel access procedure during the first COT (1006). The WTRU may transmit a third transmission indicating the first HARQ feedback during the first transmission occasion (1008). The WTRU may determine a second HARQ feedback for the transport block (1010). The WTRU may determine, from one or more transmission occasions, a second transmission occasion that satisfies the latency bound (1012). In various embodiments, the transmission occasions may be configured (e.g., preconfigured).

The WTRU may perform a second channel access procedure and establish a second COT, e.g., for device-to-device communications at the second transmission occasion (1014). The WTRU may transmit a fourth transmission indicating the second HARQ feedback at the second transmission occasion during the second COT (1016).

In various embodiments, any of the initial transmissions and the second transmission may be and/or may include a PSCCH transmission, a PSSCH transmission, or a combination of a PSCCH/PSSCH transmission. In various embodiments, the second transmission occasion may be based on a PSSCH-to-PSFCH association between different COTs.

In various embodiments, the first control information may be and/or may include SCI. In various embodiments, the first transmission occasion may be and/or may include a transmission occasion for a PSFCH transmission.

In various embodiments, the WTRU may determine one or more resources for the fourth transmission in terms of a frequency allocation based on any of a transmission occasion index, a source identifier, a destination identifier and a COT index (not shown). In various embodiments, the frequency allocation may be and/or may include any of a resource block, a resource block interlace, a sub-channel, a cyclic shift and a cyclic shift index.

In various embodiments, the WTRU may determine first HARQ feedback for the transport block for the initial transmission. In various embodiments, the WTRU may determine the second HARQ feedback for the transport block for the initial transmission and the second transmissions collectively.

In various embodiments, the second COT is initiated by the WTRU or another WTRU. In various embodiments, the WTRU is a first WTRU, the first COT is initiated by a second WTRU, and the WTRU may receive the initial transmission and the second transmission from the second WTRU.

In various embodiments, the second transmission occurs after at least one fifth transmission of third control information and the same transport block. In various embodiments, the third control information indicates any of the first transmission occasion and the latency bound.

In various embodiments, the WTRU may determine the second HARQ feedback for the transport block for the initial transmission, the at least one fifth transmission and the second transmissions collectively.

In various embodiments, the first channel access procedure may be and/or may include a type 1 channel access procedure. In various embodiments, the second channel access procedure may be and/or may include a type 2 channel access procedure.

FIG. 11 is a flow chart illustrating an example flow 1100 for carrying out non-contiguous initial transmission and HARQ re-transmission within a single COT. The flow 1100 and accompanying disclosures herein may be considered a generalization of at least some of the disclosures above and are considered to encompass and/or include various embodiments of the disclosures above (e.g., the various embodiments for carrying out non-contiguous initial transmission and HARQ re-transmission within a single COT disclosed herein). The flow 1100 may be carried out using the architecture of the communications system 100 of FIGS. 1A-1D. The flow 1100 may be carried out using other architectures as well.

Referring to FIG. 11, a WTRU may determine channel is available within a COT at a time between an initial transmission and a transmission opportunity for performing a HARQ re-transmission (1102). The WTRU may perform non-contiguous initial transmission and HARQ re-transmission within the COT based on determining the channel is available (1102).

FIG. 12 is a flow chart illustrating an example flow 1200 for carrying out non-contiguous initial transmission and HARQ re-transmission within two or more COTs. The flow 1200 and accompanying disclosures herein may be considered a generalization of at least some of the disclosures above and are considered to encompass and/or include various embodiments of the disclosures above (e.g., the various embodiments for non-contiguous initial transmission and HARQ re-transmission within two or more COTs disclosed herein). The flow 1200 may be carried out using the architecture of the communications system 100 of FIGS. 1A-1D. The flow 1200 may be carried out using other architectures as well.

Referring to FIG. 12, a WTRU may determine a channel is not available within a first COT at a time following an initial transmission and a transmission opportunity for performing a HARQ re-transmission (1202). The WTRU may perform non-contiguous initial transmission and HARQ re-transmission within the first COT and a second COT based on determining the channel is not available (1204).

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.) and/or “permissive” terms (e.g., the term “is” and/or the term “are” may be interpreted as “may” and/or “might”, the terms “refer(s)” may be interpreted as “may refer” and/or “might refer”, the terms “receive(s)” may be interpreted as “may receive” and/or “might receive”, the terms “support(s)” may be interpreted as “may support” and/or “might support”, the terms “interface(s)” may be interpreted as “may interface” and/or “might interface”, the terms “transmit(s)” may be interpreted as “may interface” and/or “might interface”, “may transmit” and/or “might transmit”, the terms “send(s)” may be interpreted as “may send” and/or “might send”, the terms “does not refer” (and/or the like) may be interpreted as “may not refer” and/or “might not refer”, the terms “does not receive” (and/or the like) may be interpreted as “may not receive” and/or “might not receive”, the terms “does not support” (and/or the like) may be interpreted as “may not support” and/or “might not support”, the terms “does not interface” (and/or the like) may be interpreted as “may not interface” and/or “might not interface”, the terms “does not transmit” (and/or the like) may be interpreted as “may not transmit” and/or “might not transmit”, the terms “does not send” (and/or the like) may be interpreted as “may not send” and/or “might not send”, etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 25 U.S.C. § 112, ¶6 or means-plus-function claim format, and any claim without the terms “means for” is not so intended.

What is claimed is:

1-17. (canceled)

18. A wireless transmit/receive unit (WTRU) comprising:
a processor configured to:
receive, during a first channel occupancy time established for device-to-device communications, an initial transmission of first control information and a transport block followed by a second transmission of second control information and the same transport block, wherein (i) at least the first control information indicates a first transmission occasion within the first channel occupancy time, and (ii) at least the second control information indicates a latency bound for reporting hybrid automatic repeat request (HARQ) feedback for the transport block;
determine a first HARQ feedback for the transport block, wherein the first HARQ feedback comprises a non-acknowledgement;
perform a first channel access procedure during the first channel occupancy time;
transmit a third transmission indicating the first HARQ feedback during the first transmission occasion;
determine a second HARQ feedback for the transport block based on (i) the first HARQ feedback comprising the non-acknowledgement and (ii) a combination of the initial transmission and the second transmission;
determine, from one or more transmission occasions, a second transmission occasion that satisfies the latency bound;
perform a second channel access procedure and establishing a second channel occupancy time for device-to-device communications at the second transmission occasion; and
transmit a fourth transmission indicating the second HARQ feedback at the second transmission occasion.

19. The WTRU of claim 18, wherein the initial transmission or the second transmission are a physical sidelink control channel (PSCCH) transmission, a physical sidelink shared channel (PSSCH) transmission, or a combination of a PSCCH transmission and a PSSCH transmission.

20. The WTRU of claim 18, wherein the first control information comprises sidelink control information, and wherein the first transmission occasion is a transmission occasion for a physical sidelink feedback channel (PSFCH) transmission.

21. The WTRU of claim 18, wherein the second transmission occasion is based on a PSSCH-to-PSFCH association between different channel occupancy times.

22. The WTRU of claim 18, wherein the processor is configured to:
determine one or more resources for the fourth transmission in terms of a frequency allocation based on any of a transmission occasion index, a source identifier, a destination identifier and a channel occupancy time index.

23. The WTRU of claim 22, wherein the frequency allocation is any of a resource block, a resource block interlace, a sub-channel, a cyclic shift and a cyclic shift index.

24. The WTRU of claim 18, wherein the first HARQ feedback is determined for the transport block for the initial transmission.

25. The WTRU of claim 18, wherein the first HARQ feedback for the transport block is determined based on the initial transmission and not based on the second transmission.

26. The WTRU of claim 18, wherein the WTRU is a first WTRU, wherein the first channel occupancy time is initiated by a second WTRU, and wherein receiving an initial transmission and a second transmission comprises receiving the initial transmission and the second transmission from the second WTRU.

27. The WTRU of claim 18, wherein the first, second, third, and fourth transmissions are performed over unlicensed spectrum.

28. A method performed by a wireless transmit/receive unit (WTRU), the method comprising:
receiving, during a first channel occupancy time established for device-to-device communications, an initial transmission of first control information and a transport block followed by a second transmission of second control information and the same transport block, wherein (i) at least the first control information indicates a first transmission occasion within the first channel occupancy time, and (ii) at least the second control information indicates a latency bound for reporting hybrid automatic repeat request (HARQ) feedback for the transport block;
determining a first HARQ feedback for the transport block, wherein the first HARQ feedback comprises a non-acknowledgement;
performing a first channel access procedure during the first channel occupancy time;
transmitting a third transmission indicating the first HARQ feedback during the first transmission occasion;
determining a second HARQ feedback for the transport block based on (i) the first HARQ feedback comprising the non-acknowledgement and (ii) a combination of the initial transmission and the second transmission;
determining, from one or more transmission occasions, a second transmission occasion that satisfies the latency bound;
performing a second channel access procedure and establishing a second channel occupancy time for device-to-device communications at the second transmission occasion; and
transmitting a fourth transmission indicating the second HARQ feedback at the second transmission occasion.

29. The method of claim 28, wherein the initial transmission or the second transmission are a physical sidelink control channel (PSCCH) transmission, a physical sidelink shared channel (PSSCH) transmission, or a combination of a PSCCH transmission and a PSSCH transmission.

30. The method of claim 28, wherein the first control information comprises sidelink control information, and wherein the first transmission occasion is a transmission occasion for a physical sidelink feedback channel (PSFCH) transmission.

31. The method of claim 28, wherein the second transmission occasion is based on a PSSCH-to-PSFCH association between different channel occupancy times.

32. The method of claim 28, wherein the method comprises:
determining one or more resources for the fourth transmission in terms of a frequency allocation based on any of a transmission occasion index, a source identifier, a destination identifier and a channel occupancy time index.

33. The method of claim 32, wherein the frequency allocation is any of a resource block, a resource block interlace, a sub-channel, a cyclic shift and a cyclic shift index.

34. The method of claim 28, wherein the first HARQ feedback is determined for the transport block for the initial transmission.

35. The method of claim 28, wherein the first HARQ feedback for the transport block is determined based on the initial transmission and not based on the second transmission.

36. The method of claim 28, wherein the WTRU is a first WTRU, wherein the first channel occupancy time is initiated by a second WTRU, and wherein receiving an initial transmission and a second transmission comprises receiving the initial transmission and the second transmission from the second WTRU.

37. The method of claim 28, wherein the first, second, third, and fourth transmissions are performed over unlicensed spectrum.
